(19) United States
(12) Patent Application Publication
(10) Pub. No.: US 2022/0097088 A1
(43) Pub. Date: Mar. 31, 2022

(54) DISPENSER AND DISPENSING CONTAINER

(71) Applicant: Kao Corporation, Tokyo (JP)

(72) Inventors: Takashi YAMADA, Machida-shi (JP); Kazuyuki UEHARA, Moka-shi (JP)

(73) Assignee: Kao Corporation, Tokyo (JP)

(21) Appl. No.: 17/428,818

(22) PCT Filed: Feb. 5, 2020
(86) PCT No.: PCT/JP2020/004287

§ 371 Date: Aug. 5, 2021

(30) Foreign Application Priority Data
Feb. 8, 2019 (JP) 2019-021470
Feb. 8, 2019 (JP) 2019-021472
Feb. 8, 2019 (JP) 2019-021537

(51) Int. Cl. B05B 11/00

(52) U.S. Cl. CPC B05B 11/303

(57) ABSTRACT

A dispenser includes a housing having a depression; an elastically deformable lid section covering an opening of the depression and forming a pump chamber together with the depression; a pressing portion arranged facing the lid section on the outside of the pump chamber, capable of pressing the lid section to a side where the volume of the pump chamber decreases, and provided to be able to enter the inside of the depression while pressing the lid section for elastic deformation; an outlet causing a liquid material inside the pump chamber to flow out toward a discharging opening when the pressing portion presses the lid section; and an inlet provided separately from the outlet and causing the liquid material to flow into the pump chamber when the pressing to the lid section by the pressing portion is released.

### TECHNICAL FIELD

The present invention relates to a dispenser and a discharge container.

### BACKGROUND ART

Conventionally, a dispenser capable of discharging a liquid material from a discharging opening is known. For example, a dispenser disclosed in Patent Literature 1 includes a chamber having a variable volume and capable of sucking and holding a fixed amount of liquid. This chamber is defined between a support structure and an elastic element. The elastic element is deformable and covers an opening of a depression, the opening being opened to the outer surface of the support structure. This dispenser further includes a lever. This lever is provided with ribs. The ribs abut on an upper portion of the outer surface of the elastic element. When the lever is operated, the ribs press and deform the above-described elastic element. This compresses the above-described chamber, so that the liquid in the above-described chamber is discharged from an outlet to the outside through a nozzle. The liquid discharge amount is determined by the maximum stroke amount of the lever. When the lever is released and the pressing to the elastic element by the ribs is released, the liquid flows into the above-described chamber from a suction pipe provided separately from the above-described outlet.

Conventionally, a dispenser capable of discharging a liquid material from a discharging opening is also known. For example, a cap of a liquid ejector disclosed in Patent Literature 2 has a cap body, a dome, and a spiral spring. In the cap body, a fitting inner tube is erected. The dome has an elastically compressible inverted-bowl shape, is installed on the outer periphery of the fitting inner tube, and covers an opening of the fitting inner tube. The spiral spring is coupled to a ring supporting the top rear surface of the dome. When the dome is pressed against a resilient force of the spiral spring, a liquid in the dome is poured out of a nozzle tip. The dome is returned to the original state due to its own elastic recovery force and the elastic recovery of the spiral spring. At this time, the liquid is sucked into the dome.

Conventionally, a discharge container including a container and a dispenser is also known. For example, Patent Literature 3 discloses a pump dispenser mounted to a container having a handle section. This dispenser includes a trigger section, a piston section, a cylinder section, a passage section, a nozzle section, and a cap section. By pressing down the trigger section to bring the trigger section close to the handle section of the container, the piston section is pressed down, so that a pressure is applied into the cylinder section, ejecting a liquid through the passage section from the nozzle section positioned ahead of the passage section. The cap section is used for attaching the dispenser to the container and attached to a mouth portion of the container by screwing or the like, for example.

### CITATION LIST

### Patent Literatures

Patent Literature 1: US 2013/0320042 A1

Patent Literature 2: JP 2001-063781 A

Patent Literature 3: JP 2014-159002 A

### SUMMARY OF INVENTION

The present invention relates to a dispenser capable of discharging a liquid material from a discharging opening (hereinafter, also referred to as a “dispenser (i)”).

The dispenser (i) includes a dispenser body having a depression.

The dispenser (i) includes a lid section. The lid section covers an opening of the depression, forms a pump chamber together with the depression, and is elastically deformable.

The dispenser (i) includes a pressing portion. The pressing portion is arranged facing the lid section on the outside of the pump chamber, can press the lid section to the side where the volume of the pump chamber decreases, and is provided to be able to enter the inside of the depression while pressing the lid section for elastic deformation.

The dispenser (i) includes an outlet. The outlet causes the liquid material inside the pump chamber to flow out toward the discharging opening when the pressing portion presses the lid section.

The dispenser (i) includes an inlet. The inlet is provided separately from the outlet and causes the liquid material to flow into the pump chamber when the pressing to the lid section by the pressing portion is released.

The present invention relates to a dispenser capable of discharging a liquid material from a discharging opening (hereinafter, also referred to as a “dispenser (ii)”).

The dispenser (ii) includes a dispenser body.

The dispenser (ii) includes a lid section. The lid section is attached to the dispenser body, forms a pump chamber together with the dispenser body, and is elastically deformable.

The dispenser (ii) includes a biasing unit. The biasing unit is arranged inside the dispenser body and can press the inner surface of the lid section.

The dispenser (ii) includes a lever. The lever is provided rotatably with respect to the dispenser body and has a pressing portion capable of pressing the outer surface of the lid section.

The pressing portion and the biasing unit are provided such that, when the biasing unit starts to press the inner surface of the lid section in response to the elastic deformation of the lid section by the pressing by the pressing portion, a pressed site of the outer surface of the lid section by the pressing portion and a pressed site of the inner surface of the lid section by the biasing unit are superimposed on each other.

By the pressing to the lid section by the pressing portion, the liquid material in the pump chamber is discharged from the discharging opening.

The present invention relates to a discharge container (hereinafter, also referred to as a “discharge container (iii)”).

The discharge container (iii) includes a container. The container has a containing section containing a liquid material, a handle section which can be held by a user, a mounting target section, and an engagement target section.

The discharge container (iii) includes a dispenser. The dispenser has a mounting section mounted to the mounting target section of the container, and an engagement section engaged with the engagement target section of the container. The dispenser discharges the liquid material from the containing section of the container from a discharging opening in response to an operation of a user.

The discharge container (iii) includes a fixing member. The fixing member fixes the dispenser to the container.

The engagement section is provided to regulate the turning of the dispenser around the mounting target section of the container by being engaged with the engagement target section.

The fixing member is provided to be able to fix the dispenser to the container in a state where the engagement section is engaged with the engagement target section.

### BRIEF DESCRIPTION OF DRAWINGS

FIG. 1 is a perspective view of a dispenser according to a first embodiment of the present invention.

FIG. 2 is a side view of the dispenser according to the same embodiment.

FIG. 3 is a top view of the dispenser according to the same embodiment.

FIG. 4 is a rear view of the dispenser according to the same embodiment.

FIG. 5 is a cross-sectional view (in a view along the V-V line of FIGS. 3 and 4) of the dispenser according to the same embodiment.

FIG. 6 is a side view for illustrating the action of the dispenser according to the same embodiment.

FIG. 7 is a top view for illustrating the action of the dispenser according to the same embodiment.

FIG. 8 is a cross-sectional view (in a view along the VIII-VIII line of FIG. 7) for illustrating the action of the dispenser according to the same embodiment.

FIG. 9 is a cross-sectional view (in a view along the IX-IX line of FIGS. 6 and 7) for illustrating the action of the dispenser according to the same embodiment.

FIG. 10 is a perspective view of a dispenser according to a second embodiment of the present invention.

FIG. 11 is a side view of the dispenser according to the same embodiment.

FIG. 12 is a cross-sectional view of the dispenser according to the same embodiment.

FIG. 13 is a cross-sectional view of a dispenser according to a third embodiment of the present invention.

FIG. 14 is a cross-sectional view for illustrating the action of the dispenser according to the first embodiment of the present invention.

FIG. 15 is a top view for illustrating the action of the dispenser according to the same embodiment.

FIG. 16 is a cross-sectional view of a dispenser according to a fourth embodiment of the present invention.

FIG. 17 is a perspective view of a discharge container according to a fifth embodiment of the present invention.

FIG. 18 is a front view of the discharge container according to the same embodiment.

FIG. 19 is a side view of the discharge container according to the same embodiment.

FIG. 20 is a cross-sectional view (in a view along the IV-IV line of FIG. 18) of the discharge container according to the same embodiment.

FIG. 21 is a cross-sectional view (in a view along the IV-IV line of FIG. 18) of a dispenser according to the same embodiment.

FIG. 22 is a cross-sectional view (in a view along the VI-VI line of FIG. 19) of the discharge container according to the same embodiment.

FIG. 23 is a cross-sectional view (in a view along the VII-VII line of FIG. 19) of the discharge container according to the same embodiment.

FIG. 24 is a perspective view of a discharge container according to a sixth embodiment of the present invention.

FIG. 25 is a cross-sectional view of the discharge container according to the same embodiment.

### DESCRIPTION OF EMBODIMENTS

The dispenser described in Patent Literature 1 is structured so that the ribs do not enter the inside of the depression opened to the outer surface of the support structure also when the lever is located at a maximum stroke position. Hence, the compression amount of the chamber is insufficient, and the amount of a liquid which can be discharged is limited. Thus, the present invention relates to a dispenser (i) capable of increasing the amount of a liquid material which can be discharged. Such a dispenser (i) is described based on first to third embodiments described later.

In the cap described in Patent Literature 2, if a lever for pressing the dome is provided, the liquid can be poured from the nozzle tip with less labor by the leverage, which is advantageous. However, when a site where the dome is pressed by the lever and a site where the dome is pressed by a resilient force of the spiral spring are deviated from each other, there is a risk that the spiral spring does not smoothly operate, so that the original function of the spiral spring cannot be obtained. In the prior art described in Patent Literature 1, there is no idea of providing the lever for pressing the dome in the first place, and thus the above-described problem relating to the function of the spiral spring is not naturally considered. Thus, the present invention relates to a dispenser (ii) capable of smoothly operating a biasing unit for returning an elastically deformable lid section, which forms a pump chamber, to the initial state in a dispenser including a lever. Such a dispenser (ii) is described based on the first embodiment and a fourth embodiment described later.

In the technique described in Patent Document 3, a user is required to adjust the position of the dispenser in the circumferential direction of a mouth portion of the container by her/himself and to fix the dispenser to the container by the cap portion while holding this position. Further, even when the dispenser is fixed to the container as described above, there is a risk that the dispenser is fixed at a position deviated from the position adjusted as described above. Therefore, a discharge container has been desired in which the dispenser can be set and fixed to the container at a predetermined position. Thus, the present invention relates to a discharge container (iii) in which a dispenser can be set and fixed to a container at a predetermined position. Such a discharge container (iii) is described based on fifth and sixth embodiments described later.

Suitable embodiments of the present invention are described in detail below with reference to the accompanying drawings. In the present description and drawings, duplicate descriptions are omitted by attaching the same signs to constituent components having substantially the same functional configurations.

### First Embodiment

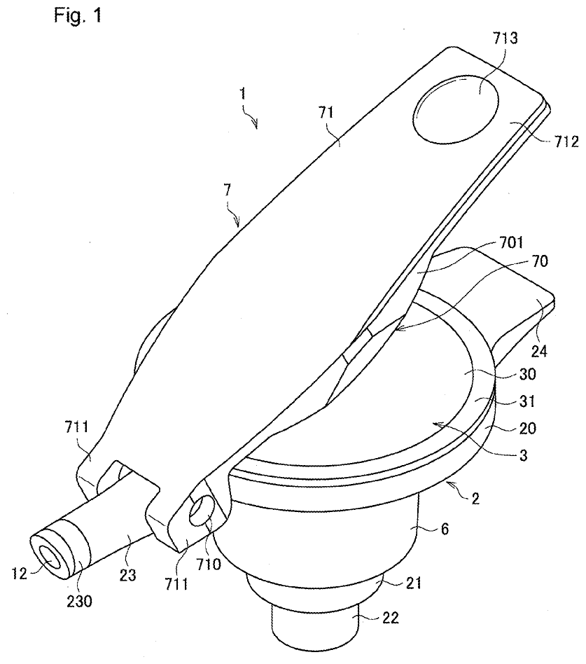

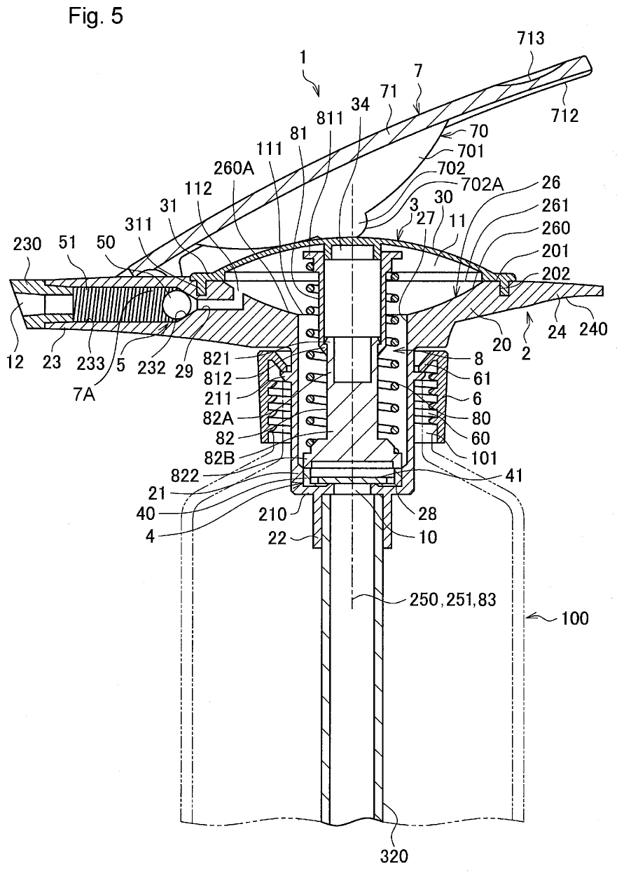

First, the dispenser (i) is described based on the first embodiment. FIGS. 1 to 5 illustrate the configuration of a dispenser 1 of this embodiment before action. The dispenser 1 is a device capable of discharging a liquid material from a discharging opening 12 in response to an extraction operation of a user. The liquid material includes a paste without being limited to a liquid and may be, for example, a liquid detergent, fabric softener, bleach, shampoo, rinse, conditioner, body soap, cosmetic liquid, pharmaceutical drug, liquid seasoning, or the like. The dispenser 1 is a so-called pump dispenser and has a suction port 10, a pump chamber 11, and the discharging opening 12 as illustrated in FIG. 5. The pump chamber 11 is provided on a passage connecting the suction port 10 and the discharging opening 12 to each other. The suction port 10 and the discharging opening 12 are separated from each other through the pump chamber 11. The dispenser 1 may discharge the liquid material as it is or may be provided with a mechanism for atomizing the liquid material and discharge the liquid material in an atomized form.

The liquid material is contained in a container 100 separate from the dispenser 1. The container 100 has a bottle shape, for example, and is mounted to the dispenser 1 to supply the liquid material to the dispenser 1. The dispenser 1 can suck the liquid material from the suction port 10. The dispenser 1 and the container 100 mounted to each other function as a discharge container. Depending on the form of the container 100, a suction pipe 320 may be connected to the suction port 10 of the dispenser 1. When a so-called delamination container including an inner layer contracting with a reduction in the liquid material contained in the delamination container is used as the container 100, the suction pipe 320 may not be connected to the dispenser 1.

The dispenser 1 includes a housing 2, an elastic member 3, a suction valve 4, a discharge valve 5, a mounting member 6, a pressing member 7, and a biasing unit 8.

As illustrated in FIGS. 1 to 5, the housing 2 has a disk section 20, a first cylindrical section 21, a second cylindrical section 22, a nozzle section 23, and a holding portion 24. As illustrated in FIG. 5, the disk section 20, the first cylindrical section 21, and the second cylindrical section 22 have a common axis 250, are stacked on each other in this order, and are reduced in diameter in this order. Hereinafter, the side of the disk section 20 is also referred to as “top” with respect to the first cylindrical section 21 and the side of the first cylindrical section 21 is also referred to as “bottom” with respect to the disk section 20 in a direction along the axis 250. However, the terms “top” and “bottom” refer to the relative positional relationship in the dispenser 1, and do not necessarily mean the “top” and the “bottom” in the vertical direction.

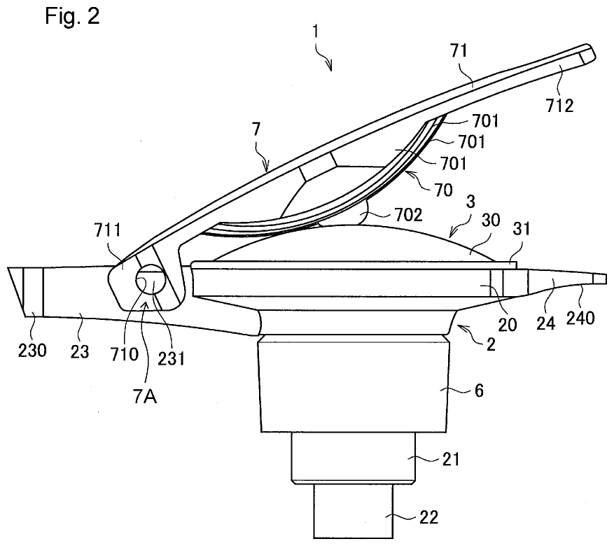

The nozzle section 23 projects from the outer edge of the disk section 20 and extends in the radial direction of the disk section 20. A cap 230 is installed at the tip of the nozzle section 23. The discharging opening 12 is opened to a tip portion of the cap 230. From each of both side surfaces of the nozzle section 23, a cylindrical projection 231 projects (see FIG. 2). These projections 231 are located on the upper side of the nozzle section 23 and extend in a direction perpendicular to the axis of the nozzle section 23.

The holding portion 24 has a plate shape and expands along a plane orthogonal to the axis 250. The holding portion 24 projects from the opposite side to the nozzle section 23 across the axis 250 in the outer edge of the disk section 20 and extends in the radial direction of the disk section 20. The holding portion 24 is provided with a shallow dent 240 in the lower surface. The dent 240 facilitates the positioning of a finger in the holding portion 24.

The first cylindrical section 21 has a bottomed cylindrical shape and projects from the lower surface of the disk section 20. The suction port 10 is opened to a bottom portion 210 at the lower end of the first cylindrical section 21. A flange-shaped projection 211 projects from the outer surface of the first cylindrical section 21. The second cylindrical section 22 has a cylindrical shape and projects from the bottom portion 210 of the first cylindrical section 21. The second cylindrical section 22 surrounds the suction port 10. As illustrated in FIG. 5, the suction pipe 320 can be connected to the second cylindrical section 22.

As illustrated in FIG. 5, a depression 26, a biasing unit containing hole 27, a suction valve containing hole 28, and a discharge passage 29 are formed inside the housing 2.

The depression 26 is formed inside the disk section 20 and opened to an upper surface 201 of the disk section 20. The depression 26 is depressed in the shape of a watch glass. A bottom portion 260 of the depression 26 has a curved surface shape in which the spherical surface is partly cut out, for example. The bottom portion 260 has a circular shape in plan view as viewed from above but may have an oval shape or the like. The bottom portion 260 may be directly continuous to the upper surface 201 of the disk section 20 or may be connected to the upper surface 201 of the disk section 20 through the inner peripheral surface extending in the axial direction of the inner surface of the depression 26. The disk section 20 is provided with an annular groove 202 surrounding an opening 261 of the depression 26 at the upper surface 201.

The biasing unit containing hole 27 is formed inside the disk section 20 and the first cylindrical section 21. The biasing unit containing hole 27 has a cylindrical shape and has one axial end opened to the bottom portion 260 of the depression 26. This opening 111 functions as an inlet to the pump chamber 11, and therefore is hereinafter referred to as the inlet 111. The inlet 111 is provided in the pump chamber 11 and opened to the bottom portion 260 of the depression 26.

The suction valve containing hole 28 is formed inside the first cylindrical section 21 and connected to the other axial end of the biasing unit containing hole 27. The suction valve containing hole 28 has a cylindrical shape with a diameter smaller than that of the biasing unit containing hole 27 and is partitioned by the bottom portion 210 of the first cylindrical section 21. The suction port 10 formed in the bottom portion 210 of the first cylindrical section 21 is connected to the suction valve containing hole 28, thereby making the suction port 10 and the depression 26 communicate with each other. More specifically, the suction port 10 communicates with the inlet 111 through the suction valve containing hole 28 and the biasing unit containing hole 27, and a passage connected to the depression 26 from the suction port 10 through the suction valve containing hole 28, the biasing unit containing hole 27, and the inlet 111 functions as a suction passage of the liquid material to the pump chamber 11.

The depression 26, the biasing unit containing hole 27, the suction valve containing hole 28, and the suction port 10 have a common axis 251 and extend along the axis 251. In this embodiment, the axis 251 is aligned with the axis 250 of the disk section 20 and the like.

The discharge passage 29 is formed inside the disk section 20 and the nozzle section 23 and opened to the bottom portion 260 of the depression 26. This opening 112 functions as an outlet from the pump chamber 11, and therefore is hereinafter referred to as the outlet 112. The outlet 112 is provided in the pump chamber 11 and opened to the bottom portion 260 of the depression 26. The outlet 112 is provided separately from the inlet 111. The outlet 112 and the inlet 111 communicate with each other only through the pump chamber 11. The opening area of the outlet 112 in the bottom portion 260 is smaller than the opening area of the inlet 111 in the bottom portion 260. The discharge passage 29 is connected to the discharging opening 12 at the tip of the nozzle section 23 and functions as a discharge passage from the pump chamber 11.

The elastic member 3 is installed on the upper surface 201 of the disk section 20. The elastic member 3 is formed using a synthetic resin, for example, as a material and has flexibility. The elastic member 3 has a lid section 30 and a flange portion 31.

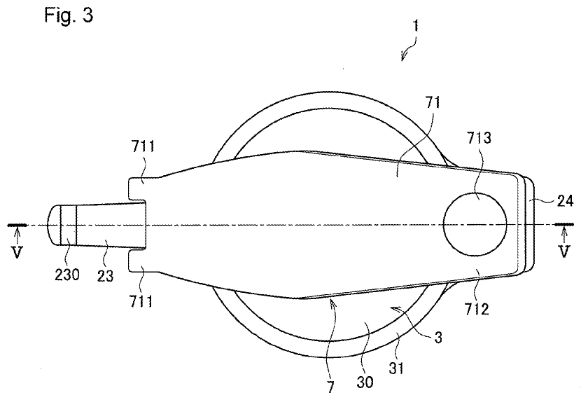

The lid section 30 is an elastically deformable membranous portion and has predetermined elasticity. The lid section 30 covers the opening 261 of the depression 26 and forms the pump chamber 11 together with the depression 26. In an initial state before the lid section 30 is deformed, the lid section 30 has a dome shape expanding upward with respect to the opening 261 of the depression 26, i.e., the side away from the bottom portion 260 of the depression 26, and has a curved surface shape in which the spherical surface is partly cut out, for example. As illustrated in FIG. 3, the lid section 30 has a circular shape in plan view as viewed from above, but may have an oval shape or the like. The thickness or the modulus of elasticity of the lid section 30 may partly vary in the surface of the lid section 30. As illustrated in FIG. 5, a cylindrical locking portion 34 projects from a center portion of the lower surface of the lid section 30, i.e., the surface facing the pump chamber 11. The outer diameter of the locking portion 34 is smaller than the diameter of an opening of the biasing unit containing hole 27 in the bottom portion 260. To reinforce the lid section 30, a plurality of ribs radially extending from the locking portion 34 and reaching the vicinity of the outer edge of the lid section 30 may be provided on the lower surface or the upper surface of the lid section 30.

The flange portion 31 is a plate-like connection portion surrounding the lid section 30. A projection 311 having an annular shape surrounding the lid section 30 projects from the lower surface of the flange portion 31. The projection 311 is fitted to the groove 202 of the disk section 20, and the lower surface of the flange portion 31 contacts the upper surface 201 of the disk section 20, thereby partitioning the pump chamber 11 and maintaining liquid tightness.

The suction valve 4 is formed of a synthetic resin and integrally has a cylindrical base 40 and a plate-like valve body 41 as illustrated in FIG. 5. The valve body 41 is connected to the base 40 at one axial end of the base 40 through a coupling portion and can be elastically axially displaced with respect to the base 40. The base 40 is fitted to the suction valve containing hole 28. The valve body 41 is installed at the bottom portion 210 of the first cylindrical section 21 to close the suction port 10. When the pressure inside the first cylindrical section 21 becomes lower than the pressure inside the second cylindrical section 22, and the thrust due to a pressure difference between them exceeds an elastic force in the above-described coupling portion, the valve body 41 is separated from the bottom portion 210 and the suction port 10 is opened. When the pressure inside the first cylindrical section 21 rises and the thrust due to the above-described pressure difference falls below the elastic force of the above-described coupling portion, the valve body 41 contacts the bottom portion 210 and the suction port 10 is closed. When the pressure inside the first cylindrical section 21 is equal to or higher than the pressure inside the second cylindrical section 22, the above-described state in which the suction port 10 is closed is maintained.

The discharge valve 5 is a ball valve and has a ball-shaped valve body 50 and a return spring 51 as illustrated in FIG. 5. The discharge valve 5 is contained in a discharge valve containing hole 233 provided inside the nozzle section 23. The valve body 50 is seated on a valve seat 232, thereby closing between the pump chamber 11 and the discharging opening 12 in the discharge passage 29. The return spring 51 is a coil spring and installed in a pressed and contracted state between an end portion of the cap 230 and the valve body 50 and normally biases the valve body 50 toward the valve seat 232. When the thrust due to the pressure on the side of the pump chamber 11 relative to the valve seat 232 is higher than the total of the thrust due to the pressure on the side of the discharging opening 12 and a biasing force of the return spring 51 in the discharge passage 29, the valve body 50 is separated from the valve seat 232 due to a pressure difference between them, the discharge passage 29 is opened, and the pump chamber 11 and the discharging opening 12 communicate with each other. When the thrust due to the pressure on the side of the pump chamber 11 falls below the total of the thrust due to the pressure on the side of the discharging opening 12 and the biasing force of the return spring 51, the valve body 50 is seated, the discharge passage 29 is closed, and the communication between the pump chamber 11 and the discharging opening 12 is blocked.

The mounting member 6 is a cylindrical cap having a threaded portion 60 formed on the inner surface and surrounds the first cylindrical section 21. The mounting member 6 is turnable with respect to the first cylindrical section 21. As illustrated in FIG. 5, an upper end 61 of the mounting member 6 is locked with the projection 211, thereby regulating the downward axial movement of the mounting member 6 with respect to the first cylindrical section 21. A user can screw a threaded portion of a mouth/neck section 101 of the container 100 into the threaded portion 60 of the mounting member 6 by inserting the mouth/neck section 101 into a gap between the outer surface of the first cylindrical section 21 and the inner surface of the mounting member 6 and turning the mounting member 6 with respect to the mouth/neck section 101. Thus, the container 100 can be fastened/fixed and mounted to the dispenser 1.

The pressing member 7 is arranged facing the upper surface of the lid section 30 on the opposite side to the pump chamber 11 across the lid section 30. The pressing member 7 is provided integrally with a lever 71 and is molded integrally with the lever 71 using a synthetic resin, for example, as a material. The lever 71 has a plate shape gently curved and projecting upward. The lever 71 has hinge portions 711 and a holding portion 712. The hinge portions 711 are located at one longitudinal end of the lever 71. The holding portion 712 is located at the other longitudinal end of the lever 71.

As illustrated in FIGS. 1 and 3, the hinge portions 711 are located on both sides in the plate width direction perpendicular to the longitudinal direction of the lever 71 and straddle and interpose the nozzle section 23. As illustrated in FIG. 2, a hole 710 is formed in the hinge portion 711. To the hole 710, the projection 231 of the nozzle section 23 is turnably fitted. The hole 710 and the projection 231 of the nozzle section 23 function as a fulcrum 7A of the lever 71. As illustrated in FIGS. 2 and 5, the fulcrum 7A is located at a height where the fulcrum 7A is superimposed on the depression 26 in the up and down direction, in other words, located between the opening 261 of the depression 26 and the deepest part of the bottom portion 260, and located at a position on the side of the opening 261 of the depression 26. Specifically, the hole 710 and the projection 231 are located at substantially the same height as the groove 202 of the disk section 20, in other words, a connection site between the elastic member 3 and the housing 2. Hereinafter, the turning direction with the fulcrum 7A of the lever 71 as the center is simply referred to as the turning direction.

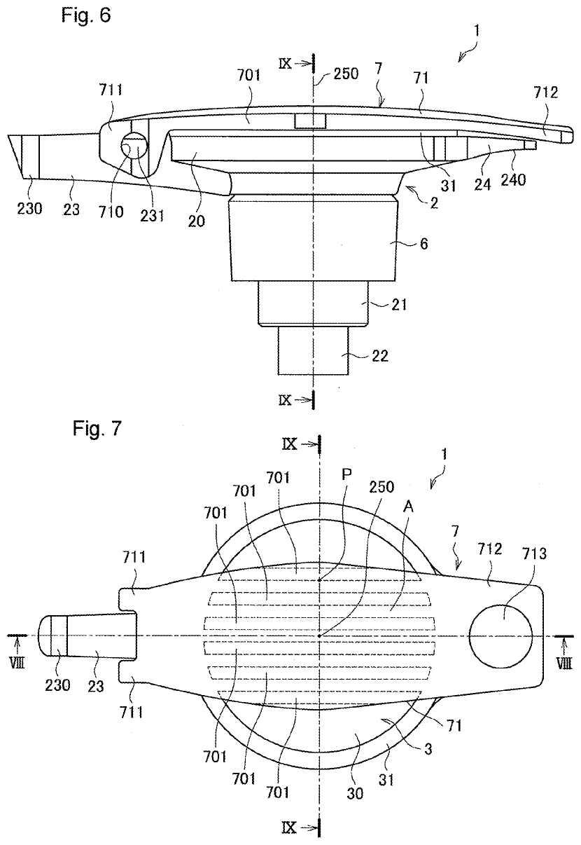

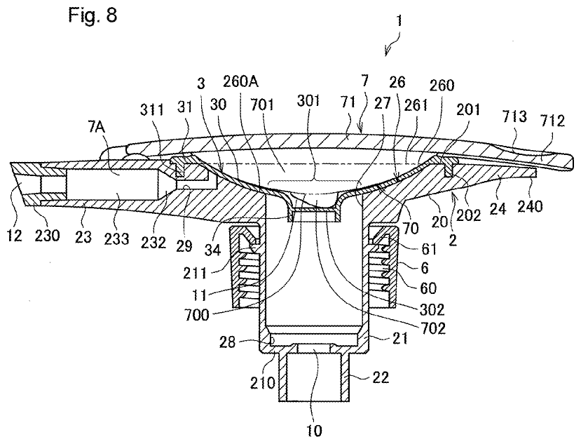

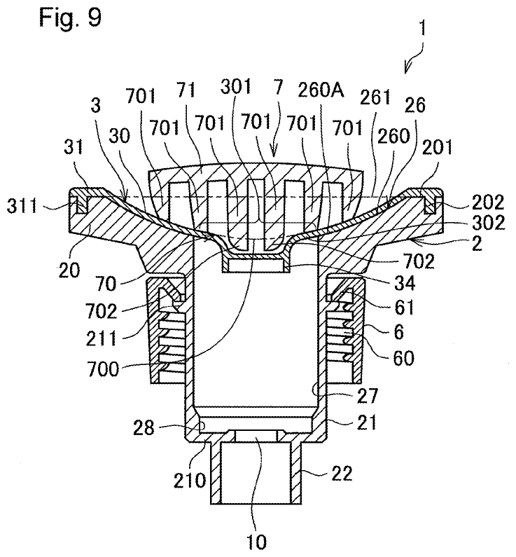

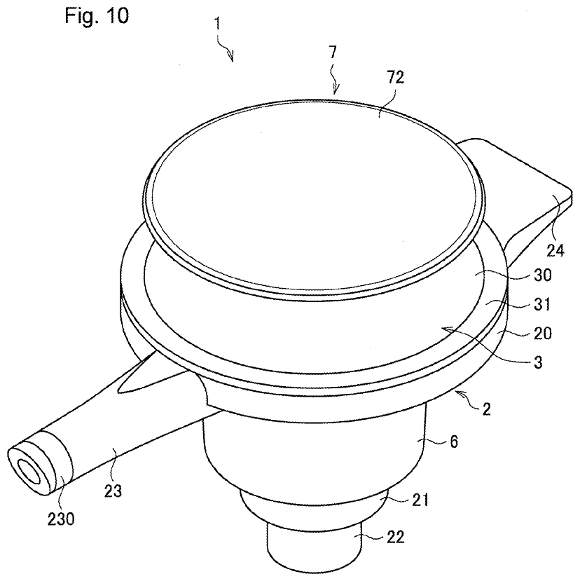

FIGS. 6 to 9 illustrate the dispenser 1 in a state where the holding portion 712 of the lever 71 is pressed down to the lowest side, in other words, the position closest to the holding portion 24 of the housing 2, and the stroke amount in the turning direction of the lever 71 is maximum, i.e., the lever 71 is located at the maximum stroke position. For simplicity, the illustration of the suction valve 4, the discharge valve 5, and the biasing unit 8 is omitted in FIGS. 8 and 9.

The holding portion 712 faces the holding portion 24 of the housing 2 in the turning direction of the lever 71. A position of the lever 71 where a pressing portion 70 abuts on the lid section 30 and immediately before the pressing portion 70 presses the lid section 30 for elastic deformation is referred to as an initial position. At the initial position of the lever 71, there is a predetermined distance between both the holding portions 24 and 712, and the holding portion 712 of the lever 71 is positioned at a predetermined height with respect to the holding portion 24 of the housing 2. The above-described predetermined distance is, for example, such a distance that it is easy for a user to hold and grasp both the holding portions 24 and 712, using one hand, with the thumb and the other arbitrary fingers. The holding portion 712 of the lever 71 functions as the point where a force is applied of the lever 71. The holding portion 712 is provided with a shallow and watch glass-shaped dent 713 in the upper surface. The dent 713 facilitates the positioning of a finger at the holding portion 712 and suppresses the finger from slipping against the holding portion 712.

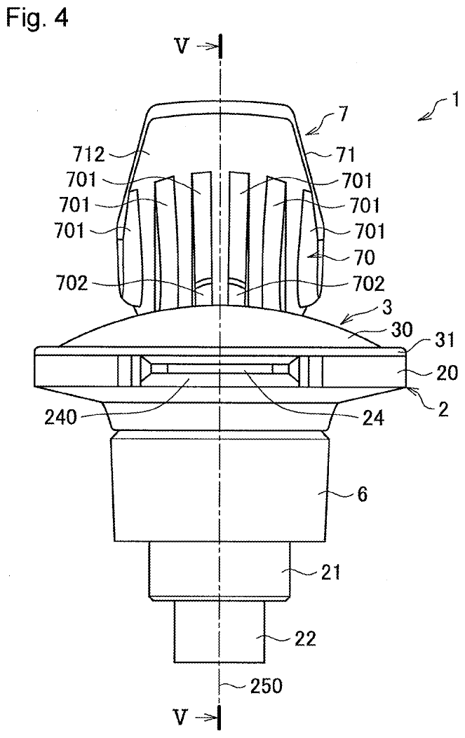

The pressing member 7 has the pressing portion 70. The pressing portion 70 is provided between the hinge portions 711 and the holding portion 712 in the lever 71 and projects from the lower surface of the lever 71. The pressing portion 70 faces the lid section 30 in the turning direction of the lever 71. As illustrated in FIGS. 4 and 7, the pressing portion 70 has a shape in which one projection is reduced in thickness in the shape of a plurality of stripes, and includes a plurality (e.g., six) of plate portions 701. Each plate portion 701 has a plate shape expanding in a direction perpendicular to the lower surface of the lever 71, and extends in the longitudinal direction of the lever 71. The thicknesses of the plate portions 701 are substantially equal to each other and substantially equal to the plate thickness of the lever 71.

Sites facing or overlapping each other in the turning direction of the lever 71, specifically a site in the tips of the pressing portion 70 and a site in the bottom portion 260 of the depression 26, are hereinafter referred to as facing sites. The tip surface of the plate portion 701 is a projecting curved surface toward the lid section 30 and has a curved surface shape in which the spherical surface is partly cut out, for example. At least a part of the tip surface of the plate portion 701 has a shape along the facing site of the bottom portion 260 and has a curvature equal to that of the facing site of the bottom portion 260, for example. At least the above-described part of the tip surface of the plate portion 701 is, for example, a portion facing a center-side site 260A of the bottom portion 260 in the turning direction of the lever 71 as illustrated in FIG. 5.

As illustrated in FIGS. 8 and 9, an imaginary envelope surface 700 passing through the tips of the plate portions 701 in common can be assumed. The envelope surface 700 is the tip surface of the pressing portion 70 and has a curved surface shape in which the spherical surface is partly cut out, for example. At least a part of the envelope surface 700 has a shape along the bottom portion 260 and has a curvature equal to that of the bottom portion 260, for example. At least the above-described part is, for example, a portion facing the center-side site 260A of the bottom portion 260 in the turning direction of the lever 71. In the plurality of plate portions 701, the envelope surface 700 serves as the tip surface.

As illustrated in FIG. 7, the tips of the pressing portion 70, i.e., the tips of the plurality of plate portions 701, are superimposed on a part of the lid section 30 in the turning direction of the lever 71. A region including the tips of the pressing portion 70 in plan view of the lever 71 is defined as a region A. At the maximum stroke position where the lever 71 is pressed down to the lowest side and the pressing portion 70 is displaced to the lowermost side, a part of the lid section 30 overlaps the region A and the other part does not overlap the region A in the turning direction of the lever 71. A part of the region A is located on the center side of the lid section 30 in the radial direction of the lid section 30, e.g., on the center side relative to a midpoint P between the outer peripheral edge and the center of the lid section 30. The other part of the region A is located on the outer peripheral edge side of the lid section 30, e.g., on the outer peripheral edge side relative to the midpoint P of the lid section 30. The above-described center of the lid section 30 may be located at or near the intersection with the axis 250 of the depression 26 and the like.

As illustrated in FIG. 7, the dimension of the region A in the longitudinal direction of the lever 71 is substantially equal to the dimension of the lid section 30 in the longitudinal direction of the lever 71 at the maximum stroke position. The dimension of the region A in the plate width direction perpendicular to the longitudinal direction of the lever 71 is larger than the radius of the lid section 30. At the maximum stroke position, the outer edge of the region A in the longitudinal direction of the lever 71 is superimposed on the outer peripheral edge of the lid section 30. The outer edge of the region A in the plate width direction of the lever 71 is located on the outer peripheral edge side of the lid section 30 relative to the midpoint P of the lid section 30.

As illustrated in FIGS. 8 and 9, the height with respect to the lever 71 at any site in the envelope surface 700 is larger than the distance from the facing site of the bottom portion 260 to the opening 261 of the depression 26, i.e., the depth of the depression 26.

As illustrated in FIGS. 4 and 5, projections 702 projecting from the tip surfaces of the plate portions 701 are provided at sites facing a center portion of the lid section 30 in the turning direction of the lever 71 of the tips of the two plate portions 701 located on the center side in the plate width direction of the lever 71. The projections 702 are located at positions overlapping the locking portion 34 of the lid section 30 and positions overlapping the opening of the biasing unit containing hole 27 in the bottom portion 260 of the depression 26 in the turning direction of the lever 71. As illustrated in FIG. 5, in a site of the projection 702 facing the lid section 30, the side of the hinge portion 711 has a linear shape and a portion 702A on the side of the holding portion 712 has a projecting curved shape, specifically a circular arc shape, as viewed from the side surface of the plate portion 701, i.e., as viewed from the turning axis direction of the lever 71. A region occupied by the two projections 702 in the longitudinal direction and in the plate width direction of the lever 71 is smaller than the opening of the biasing unit containing hole 27 in the bottom portion 260. At the initial position of the lever 71, the linear portions of both the projections 702 abut on a center portion in the upper surface of the lid section 30.

As illustrated in FIG. 5, the biasing unit 8 has a first support 81, a second support 82, and a coil spring 80.

The first support 81 has a cylindrical shape and is provided with a first flange portion 811 expanding to the radially outside at one axial end thereof and a second flange portion 812 extending to the radially inside at the other axial end thereof. The second support 82 has a shape in which a bottomed cylindrical portion 82A and a plate-like portion 82B are combined. At one axial end of the second support 82, i.e., an end portion on the side of an opening of the bottomed cylindrical portion 82A, a first flange portion 821 extending to the radially outside is provided. At the other axial end of the second support 82, i.e., an end portion of the plate-like portion 82B, a second flange portion 822 extending to the radially outside is provided.

The second support 82 is fitted to the inner periphery of the first support 81. Both the supports 81 and 82 are slidable with respect to each other. The engagement of the second flange portion 812 of the first support 81 with the first flange portion 821 of the second support 82 restrains the second support 82 from coming out of the first support 81. Thus, the maximum axial dimension of the biasing unit 8 is defined. The coil spring 80 is installed to surround the outer peripheries of both the supports 81 and 82. The coil spring 80 is installed in a normally pressed and contracted state between the first flange portion 811 of the first support 81 and the second flange portion 822 of the second support 82. In the initial state where the coil spring 80 reaches the maximum length and the flange portions 812 and 821 are engaged with each other, the axial dimension of the biasing unit 8 is maximum.

A part of the biasing unit 8 is installed in the biasing unit containing hole 27. The first flange portion 811 of the first support 81 as one axial end of the biasing unit 8 is located inside the pump chamber 11 and faces the lower surface of the lid section 30. The locking portion 34 of the lid section 30 is fitted to the inner periphery of the first flange portion 811.

Thus, the first support 81 is locked with the lid section 30 and the movement of the first support 81 in the radial direction of the lid section 30 is regulated. Due to the fact that a part of the lid section 30 also serves as the locking portion 34, an increase in the number of parts can be suppressed and a size reduction of the dispenser 1 can be achieved.

The second flange portion 822 of the second support 82 as the other axial end of the biasing unit 8 is located inside the biasing unit containing hole 27 and faces the suction valve 4. A space on the inner periphery side of the base 40 of the suction valve 4 is connected to spaces on both sides across the plate-like portion 82B of the second support 82, and the spaces on both sides function as a part of a suction passage. Due to the fact that the outer edge of the second flange portion 822 abuts on the inner surface of the biasing unit containing hole 27, the movement of the second support 82 in the radial direction of the biasing unit containing hole 27 is regulated.

The maximum value of the axial dimension of the biasing unit 8 is set such that the biasing unit 8 does not press the lid section 30 upward in the initial state before the pressing portion 70 deforms the lid section 30. For example, there is a gap between the first flange portion 811 of the first support 81 and the lid section 30 in the turning direction of the lever 71, and the first flange portion 811 of the first support 81 as the one axial end of the biasing unit 8 is provided not to abut on the elastic member 3 in the above-described initial state. Thus, a reduction in the durability of the lid section 30 caused due to the lid section 30 being normally deformed can be suppressed. At the initial position, there may be a gap between the pressing portion 70 and the lid section 30.

Next, the action is described. When the pressing member 7 is operated, i.e., the holding portion 712 of the lever 71 is pressed down from the initial position, the pressing portion 70 functions as the point of action of the lever 71 and presses the lid section 30 downward. The pressing portion 70 presses the lid section 30 to the side toward the bottom portion 260 of the depression 26, i.e., the side where the volume of the pump chamber 11 decreases, for elastic deformation. The plurality of plate portions 701 functions as a single projection with the envelope surface 700 being the tip surface. The lid section 30 is deformed into a shape following the envelope surface 700, i.e., a curved surface shape projecting toward the inside of the pump chamber 11.

When the lever 71 is pressed down to a position along the upper surface 201 of the disk section 20, a further displacement of the lever 71 is suppressed. A position of the pressing member 7 at this time is the maximum stroke position. A stopper may be separately provided to regulate the upper limit of the displacement amount in the lever 71. As illustrated in FIGS. 7 and 8, the pressing portion 70 abuts on the upper surface of the lid section 30 in the entire range in a predetermined radial direction, e.g., in the longitudinal direction of the lever 71, at the maximum stroke position. As illustrated in FIGS. 8 and 9, a gap between the lid section 30 and the bottom portion 260 of the depression 26 is minimum and the lower surface of the lid section 30 is along the bottom portion 260 at the maximum stroke position.

The pump chamber 11 is provided on a passage connecting the suction port 10 and the discharging opening 12 to each other. Hence, a liquid material is sucked into the pump chamber 11 from the suction port 10 and the above-described liquid material inside the pump chamber 11 is discharged toward the discharging opening 12 with the expansion and contraction of the pump chamber 11. Specifically, the pump chamber 11 is provided with the inlet 111 and the outlet 112. When the pressing portion 70 presses the lid section 30, the lid section 30 is deformed, reducing the volume of the pump chamber 11, for example. Thus, the pressure inside the pump chamber 11 becomes higher than the external pressure, e.g., atmospheric pressure. The suction valve 4 is closed, the discharge valve 5 is opened, and the liquid material inside the pump chamber 11 flows out of the outlet 112 toward the discharging opening 12 to be discharged from the discharging opening 12 through the discharge passage 29. A user can adjust the discharge amount as appropriate by adjusting the operation amount of the pressing member 7, i.e., the pressing-down amount of the lever 71. When the pressing to the lid section 30 by the pressing portion 70 is released, e.g., when an operation force input to the holding portion 712 is reduced, the lid section 30 is elastically deformed toward the initial state. More specifically, when the holding portion 712 is returned toward the initial position, the pressing portion 70 is displaced upward. The lid section 30 is elastically deformed toward the initial state by its own elastic recovery force and a pressing force of the biasing unit 8. This increases the volume of the pump chamber 11 and reduces the pressure inside the pump chamber 11 to be lower than the external pressure. The discharge valve 5 is closed, the suction valve 4 is opened, and the liquid material from the container 100 flows into the pump chamber 11 from the inlet 111 through the suction passage to be sucked into the pump chamber 11.

As described above, the suction valve 4 may be provided which blocks the communication between the suction port 10 and the inlet 111 when the pressing portion 70 presses the lid section 30. In this case, the flow of the liquid material from the pump chamber 11 toward the suction port 10 can be suppressed, and the liquid material can be caused to efficiently flow out of the inside of the pump chamber 11 toward the discharging opening 12. A configuration may acceptable in which the suction valve 4 is provided in the inlet 111, for example, without being limited to the space between the suction port 10 and the inlet 111, and the inlet 111 is closed when the pressing portion 70 presses the lid section 30. A member constituting the inlet 111 and a member constituting the suction valve 4 may be integrated with each other. The suction port 10 may be integrated with the inlet 111.

Further, the discharge valve 5 may be provided which blocks the communication between the discharging opening 12 and the outlet 112 when the pressing to the lid section 30 by the pressing portion 70 is released. In this case, the suction of the air from the discharging opening 12 into the pump chamber 11 can be more easily suppressed, and the liquid material from the suction port 10 can be caused to efficiently flow into the pump chamber 11. A configuration may be acceptable in which the discharge valve 5 is provided in the outlet 112, for example, without being limited to a space between the outlet 112 and the discharging opening 12, and the outlet 112 is closed when the pressing to the lid section 30 by the pressing portion 70 is released. A member constituting the outlet 112 and a member constituting the discharge valve 5 may be integrated with each other. The discharging opening 12 may be integrated with the outlet 112.

The inlet 111 and the outlet 112 may be opened to the bottom portion 260 of the depression 26. In this case, the inlet 111 and the outlet 112 can be simply provided in the pump chamber 11, simplifying the configuration of the pump chamber 11. The opening area of the outlet 112 may be smaller than the opening area of the inlet 111. In this case, the strength of the outflow of the liquid material from the pump chamber 11 through the outlet 112 can be improved and the inflow of the liquid material into the pump chamber 11 through the inlet 111 can be promoted.

Next, advantages of the above-described configurations are described. The housing 2 having the depression 26 functions as the dispenser body. The lid section 30 is elastically deformable and is attached to the housing 2 as the dispenser body. The elastically deformable lid section 30 covers the opening 261 of the depression 26 and forms the pump chamber 11 together with the depression 26. Hence, as compared with a case where a piston forms the pump chamber 11, for example, the diameter of the pump chamber 11 can be easily increased and the discharge amount from the pump chamber 11 by a single pressing operation of a user, i.e., the supply amount to the outside of the dispenser 1, can be increased. In other words, the dischargeable amount from the pump chamber 11 can be increased with a small displacement amount of the pressing portion 70, i.e., a small operation amount of the lever 71. The bottom portion 260 of the depression 26 has a circular shape in plan view, and therefore the diameter of the pump chamber 11 can be efficiently increased. The pressing portion 70 is arranged facing the lid section 30 on the outside of the pump chamber 11 and can press the lid section 30 to the side where the volume of the pump chamber 11 decreases. Due to the fact that the pressing portion 70 is provided as described above, the lid section 30 can be efficiently pressed down and the dischargeable amount from the pump chamber 11 can be increased with a small operation amount. In other words, due to the fact that the lid section 30 and the pressing portion 70 are provided, the dischargeable amount from the pump chamber 11 can be increased with a small displacement amount of the pressing portion 70, i.e., a small operation amount of the pressing member 7. The lid section 30 may be membranous. In this case, the diameter of the pump chamber 11 can be more easily increased and the lid section 30 can be more easily deformed into a shape following the pressing portion 70.

The lid section 30 may have a portion projecting upward with respect to the opening 261 of the depression 26, i.e., the side away from the depression 26, in the initial state. This projecting portion may form a part or the entire of the lid section 30. In this case, a large volume of the pump chamber 11 in the initial state can be easily secured. The deformation amount from the initial state of the lid section 30, i.e., the volume change amount of the pump chamber 11, can be increased and the dischargeable amount from the pump chamber 11 can be increased. In other words, a large difference between the maximum and the minimum of the volume of the pump chamber 11 can be secured and the maximum discharge amount can be increased. The lid section 30 may have a flat surface shape expanding along the upper surface 201 of the disk section 20 or may have a shape projecting downward with respect to the opening 261 of the depression 26, i.e., to the side approaching the bottom portion 260 of the depression 26. The lid section 30 may also be formed of an elastic material.

The lid section 30 may have a portion bulging upward, i.e., to the side away from the bottom portion 260 of the depression 26 (e.g., a dome-shaped portion). The bulging portion may form a part or the entire of the lid section 30. In this case, when the above-described bulging portion of the lid section 30 is deformed from the initial state, the bulging direction of the above-described portion is reversed from the side away from the bottom portion 260 to the side toward the bottom portion 260. Hence, the volume change amount of the pump chamber 11 can be efficiently increased and the dischargeable amount from the pump chamber 11 can be efficiently increased. The shape of the above-described bulging portion is not limited to the dome shape.

The pressing portion 70 can enter the inside of the depression 26 while pressing the lid section 30 for elastic deformation. In other words, at least a part of the pressing portion 70 can be positioned inside the depression 26, and the lid section 30 can be deformed inside the depression 26 following at least the above-described part of the pressing portion 70. Due to the fact that the lid section 30 is brought close to the bottom portion 260 of the depression 26, the lid section 30 can be greatly deformed from the initial state using the internal space of the depression 26 and the volume reduction amount of the pump chamber 11 can be increased. More specifically, the volume change amount of the pump chamber 11 can be increased and the dischargeable amount from the pump chamber 11 can be increased. In other words, as compared with a structure in which the pressing portion 70 does not enter the inside of the depression 26 when the pressing portion 70 is maximally displaced, the maximum discharge amount can be increased by efficiently using the volume of the depression 26. By effectively utilizing the space inside the housing 2 as described above, a size reduction of the dispenser 1 can be achieved. When the biasing unit 8 is provided, the lid section 30 can be easily returned to the initial state even when the lid section 30 is greatly deformed from the initial state. At least the above-described part of the pressing portion 70 may be positioned outside the depression 26 in the initial state. In this case, when the pressing member 7 is operated, at least the above-described part can be positioned inside the depression 26. Hence, the deformation amount from the initial state of the lid section 30 can be increased and the dischargeable amount from the pump chamber 11 can be increased.

Specifically, the lid section 30 pressed by the pressing portion 70 is elastically deformed into the shape along the depression 26 in the state where the pressing portion 70 enters the inside of the depression 26. Hence, the lid section 30 can be more effectively brought close to the bottom portion 260 of the depression 26.

The lid section 30 may bulge to the opposite side to the side of the depression 26. Specifically, the lid section 30 may have a shape bulging upward with respect to the opening 261 of the depression 26, i.e., to the side away from the bottom portion 260 of the depression 26, in the initial state. In this case, the volume change amount of the pump chamber 11 can be more efficiently increased and the dischargeable amount from the pump chamber 11 can be more efficiently increased. In the initial state, the height of the lid section 30, i.e., the maximum distance from the opening 261, may be smaller than the maximum radius of the lid section 30, i.e., the maximum value of the radius (maximum radius) of the lid section 30 in the opening 261, and may be 20% or less of the above-described maximum radius, for example. In this case, the size reduction of the dispenser 1 can be achieved by suppressing the height of the lid section 30. Meanwhile, due to the fact that the maximum radius of the lid section 30 is relatively increased, a large maximum volume of the pump chamber 11 can be secured. Since the lid section 30 has a circular shape in plan view, the volume change amount of the pump chamber 11 can be efficiently increased. Herein, when at least a part of the pressing portion 70 can be positioned inside the depression 26, a large deformable range of the lid section 30 can be secured even when the height of the lid section 30 is suppressed as described above. Hence, the volume change amount of the pump chamber 11 can be increased and the dischargeable amount from the pump chamber 11 can be increased.

The pressing portion 70 may be provided to press the lid section 30 for elastic deformation, thereby allowing ⅓ or more of the lid section 30 to enter the inside of the depression 26. For example, the pressing portion 70 may be able to deform the lid section 30 such that ⅓ or more, e.g., a half or more, of the lower surface of the lid section 30 is positioned inside the depression 26. In this case, the dischargeable amount from the pump chamber 11 can be increased by efficiently using the volume of the depression 26.

The pressing portion 70 may be able to partly or entirely deform the surface of the lid section 30 toward the inside of the depression 26. In this case, the volume of the pump chamber 11 can be efficiently reduced and the dischargeable amount from the pump chamber 11 can be increased with a small displacement amount of the pressing portion 70, i.e., a small operation amount of the pressing member 7.

The pressing portion 70 may be able to abut on the upper surface of the lid section 30 in the entire range in the predetermined radial direction. In this case, the pressing portion 70 can deform the lower surface of the lid section 30 in the entire range at least in the above-described predetermined radial direction toward the inside of the depression 26.

This can efficiently reduce the volume of the pump chamber 11 and increase the dischargeable amount from the pump chamber 11 with a small displacement amount of the pressing portion 70, i.e., a small operation amount of the pressing member 7.

A part of the pressing portion 70 may maintain a non-contact state with the lid section 30 during the deformation of the lid section 30. In this case, the friction between the pressing portion 70 and the lid section 30 can be reduced and the deformation of the lid section 30 can be smoothened. When a part of the lid section 30 is pressed, the other portion of the lid section 30 is pulled and deformed by tension. Hence, not only the above-described part but the entire, for example, of the lid section 30 can be deformed.

Apart of the pressing portion 70 may be able to abut on the center side in the radial direction in the surface of the lid section 30. In this case, a tension deviation in the surface of the lid section 30 is suppressed, and therefore the friction between the pressing portion 70 and the lid section 30 can be reduced and the deformation of the lid section 30 can be smoothened. When the center side of the surface of the lid section 30 is pressed, the outer peripheral edge side of the lid section 30 is pulled toward the center side and deformed by tension. Hence, the lid section 30 is easily efficiently deformed.

A part of the pressing portion 70 may be able to abut on the outer peripheral edge side in the radial direction in the surface of the lid section 30. In this case, not only the center side but the outer peripheral edge side of the surface of the lid section 30 is pressed, thereby facilitating the deformation of the entire of the lid section 30.

Specifically, the region A including the tips of the pressing portion 70 in plan view of the lever 71 can press the lid section 30 as illustrated in FIG. 7. A part of the region A may be located on the center side in the radial direction of the surface of the lid section 30, and the other part of the region A may be located on the outer peripheral edge side in the radial direction of the surface of the lid section 30. In this case, both the center side and the outer peripheral edge side are pressed, thereby facilitating the deformation of the entire of the lid section 30.

The dimension of the region A in the plate width direction perpendicular to the longitudinal direction of the lever 71 is larger than the radius of the lid section 30. The region A can contact the lid section 30. In other words, the smallest dimension (equivalent to the dimension in the above-described plate width direction of the region A) in plan view of the depression 26 of a region which can be pressed by the pressing portion 70 of the lid section 30 is larger than the radius of the lid section 30. Hence, a large number of regions in the lid section 30 can be pressed by the pressing portion 70, and therefore the entire of the lid section 30 is easily deformed. Further, due to the fact that the center of the lid section 30 is included in the region which can be pressed by the pressing portion 70, the lid section 30 can be easily smoothly and efficiently deformed.

The outer edge of the region A in the above-described plate width direction of the lever 71 is located on the outer peripheral edge side of the lid section 30 relative to the midpoint P between the outer peripheral edge and the center of the lid section 30. In other words, the outer edge of the region which can be pressed by the pressing portion 70 of the lid section 30 is located on the outer peripheral edge side of the lid section 30 relative to the midpoint P. Hence, the region including the outer peripheral edge side in the lid section 30 can be pressed by the pressing portion 70, and therefore the entire of the lid section 30 is easily deformed.

At the maximum stroke position of the pressing member 7, a gap between the lid section 30 and the bottom portion 260 of the depression 26 is permissible. When the above-described gap is small at the maximum stroke of the pressing member 7, the dischargeable amount from the pump chamber 11 can be efficiently increased. The volume of the above-described gap at the maximum stroke position may be, for example, 5% or less and more preferably 2% or less based on the maximum discharge amount from the pump chamber 11. In these cases, the dischargeable amount from the pump chamber 11 can be effectively increased. The pressing member 7 may be able to cause a part of the lid section 30 to abut on the bottom portion 260 of the depression 26. For example, the pressing member 7 may be able to cause the lower surface of the lid section 30 to abut on the bottom portion 260 of the depression 26 in a half or more of the area of the bottom portion 260 of the depression 26 or may be able to cause at least a part of the lower surface of the lid section 30 and the bottom portion 260 of the depression 26 to abut on each other with the surfaces. In either case, the above-described gap can be more reliably reduced.

The depression 26 may have such a shape that the depth gradually increases toward the center side from the outer peripheral edge of the depression 26. In this case, the gap between the lid section 30 and the bottom portion 260 of the depression 26 can be easily reduced without forcibly deforming the lid section 30 in and near the outer peripheral edge of the depression 26 while securing the volume of the depression 26. For example, the above-described gap is reduced in and near the outer peripheral edge of the depression 26 at the maximum stroke of the pressing member 7, thereby enabling an increase in the dischargeable amount from the pump chamber 11. For example, the depression 26 may be depressed in the shape of a watch glass.

The facing sites at the tips of the pressing portion 70 to a site where the distance from the opening 261 (depth) is large of the bottom portion 260 of the depression 26 may have a distance to the lever 71 (height) larger than that in the facing sites at the tips of the pressing portion 70 to a site where the above-described distance (depth) is small of the bottom portion 260. In other words, the facing sites at the tips of the pressing portion 70 to the site where the distance from the opening 261 (depth) is large of the bottom portion 260 of the depression 26 may have such a distance that the pressing portion 70 can enter the depression 26 from the opening 261 larger than that in the facing sites at the tips of the pressing portion 70 to the site where the above-described distance (depth) is small of the bottom portion 260. In this case, even when the depth of the depression 26 varies depending on the radial position in the depression 26, the distance between the tips of the pressing portion 70 and the bottom portion 260 of the depression 26 can be reduced at any site of the pressing portion 70 at the maximum stroke of the pressing member 7. This can reduce the gap between the lid section 30 and the bottom portion 260 of the depression 26 and increase the dischargeable amount from the pump chamber 11.

The pressing portion 70 may have a shape corresponding to the depression 26. For example, at least a part of the tips of the pressing portion 70 may have a shape along the bottom portion 260 of the depression facing it in the turning direction of the lever 71. In this case, the gap between the lid section 30 and the bottom portion 260 of the depression 26 at the maximum stroke of the pressing member 7 can be easily reduced irrespective of the radial position in the depression 26.

Specifically, the curvature of at least a part of the tip surface of the pressing portion 70, i.e., the envelope surface 700, may be equal to the curvature of the facing site of the bottom portion 260. In this case, the lower surface of the lid section 30 deformed into a shape following the envelope surface 700 approaches the bottom portion 260 of the depression 26, enabling a reduction in the gap between the lid section 30 and the bottom portion 260 of the depression 26 at the maximum stroke of the pressing member 7. The curvature of the entire of the envelope surface 700 may be equal to the curvature of the facing site of the bottom portion 260. In this case, the above-described gap at the maximum stroke of the pressing member 7 can be reduced irrespective of the radial position in the depression 26. The curvature of at least a part of the envelope surface 700 may be equal to or larger than the curvature of the facing site of the bottom portion 260. In this case, the lid section 30 can easily approach the bottom portion 260 of the depression 26. Conversely, the curvature of at least a part of the envelope surface 700 may be equal to or smaller than the curvature of the facing site of the bottom portion 260. In this case, the pressing portion 70 easily contacts the lid section 30 in a wider range in the radial direction at the maximum stroke of the pressing member 7.

The pressing portion 70 may have a stripe-shaped irregular shape, i.e., the plurality of plate portions 701. In this case, the pressing portion 70 can be reduced in thickness and a difference in the thickness between each part in the pressing member 7 can be reduced. Hence, when the pressing member 7 is formed of a resin, shrinkage, i.e., a reduction in the thickness, can be suppressed and the moldability can be improved. The opposite side to the side of the lid section 30 of the pressing member 7, i.e., the upper surface side, is not depressed due to the shrinkage and the shape of the upper surface can be flattened, for example, and therefore the appearance can be improved.

At least a part of the tip of each plate portion 701 constituting the pressing portion 70 or the envelope surface 700 thereof, i.e., the tip surface of the pressing portion 70, may have a shape along the facing site of the bottom portion 260 of the depression 26. In this case, the deformation of the lid section 30 into the shape along the bottom portion 260 of the depression 26 can be facilitated. For example, the curvature of at least a part of the tip surface of each plate portion 701 or the envelope surface 700 thereof, i.e., the tip surface of the pressing portion 70, may be equal to the curvature of the facing site of the bottom portion 260.

The pressing portion 70 may have a single projection projecting toward the side of the lid section 30 instead of having the stripe-shaped irregularities. In this case, a difference between the plate thickness in the above-described projection and the plate thickness in the other site may be reduced by forming the side opposite to the lid section 30 in the above-described projection into a depressed shape. This also can suppress the shrinkage in the pressing member 7.

The biasing unit 8 may be able to press the lid section 30 to the side where the volume of the pump chamber 11 increases. In this case, even when the deformation amount from the initial state of the lid section 30 due to being pressed by the pressing portion 70 increases, the lid section 30 can be easily returned to the initial state by biasing the lid section 30 toward the initial state by the biasing unit 8, not only by the elastic recovery force of the lid section 30. For example, even when the viscosity of a liquid inside the pump chamber 11 is high, the biasing unit 8 can more reliably and quickly return the lid section 30 to the initial state.

A site where the pressing portion 70 presses the lid section 30 when the pressing member 7 strokes from the initial position and a site which can be pressed by the biasing unit 8 of the lid section 30, specifically the locking portion 34 and the vicinity thereof, may be superimposed on each other in the turning direction of the lever 71. In this case, when the pressing member 7 strokes from the initial position, the site which is pressed by the biasing unit 8 of the lid section 30 is pressed by the pressing portion 70, and therefore a force is more directly input to the biasing unit 8 from the pressing portion 70. Hence, the lid section 30 can be easily deformed toward the bottom portion 260 of the depression 26. The operation of the biasing unit 8 can also be smoothened. In particular, when the biasing unit 8 has the coil spring 80 as a biasing member, a force acts in a direction along the axis of the coil spring 80, and therefore the coil spring 80 can smoothly contract. Further, when the biasing unit 8 has the supports 81 and 82 sliding with respect to each other, these supports 81 and 82 can smoothly slide.

The biasing unit containing hole 27 may be opened to the bottom portion 260 of the depression 26. In this case, a large dimension of the biasing member can be secured by containing the biasing unit 8 in the biasing unit containing hole 27, and therefore a moderate biasing force can be easily obtained. Further, the biasing unit 8 can be easily supported inside the housing 2.

As illustrated in FIGS. 8 and 9, the pressing portion 70 may be provided to press the lid section 30 for elastic deformation, thereby allowing a part of the lid section 30 to enter the inside of the biasing unit containing hole 27. In this case, the other part of the lid section 30 can be brought closer to the bottom portion 260 of the depression 26. The above-described part of the lid section 30 entering the inside of the biasing unit containing hole 27 may be the locking portion 34. Specifically, the locking portion 34 is located at a position facing, in the turning direction of the lever 71, the opening of the biasing unit containing hole 27 in the bottom portion 260 of the depression 26. The outer diameter of the locking portion 34 is smaller than the diameter of the opening of the biasing unit containing hole 27. The height or the shape of the pressing portion 70 may be set to allow the locking portion 34 to enter the inside from the opening of the biasing unit containing hole 27. In this case, the gap between the lid section 30 and the bottom portion 260 is suppressed from increasing due to the interruption by the locking portion 34, and therefore the above-described gap at the maximum stroke can be reduced.

Due to the fact that the dispenser 1 includes the elastically deformable lid section 30, the diameter of the pump chamber 11 can be increased, whereas a relatively large force is required to deform the lid section 30 to reduce the volume of the pump chamber 11. When the dispenser 1 includes the biasing unit 8, a force is required which reduces the volume of the pump chamber 11 against the force of the biasing unit 8. To deform the lid section 30 and bring it close to the bottom portion 260 of the depression 26, a larger force is required. In contrast, it may be acceptable that the dispenser 1 further includes the lever 71 rotatable with respect to the housing 2 as the dispenser body, and the pressing portion 70 has a projection shape projecting from the lever 71 to the side of the lid section 30. In this case, when the pressing portion 70 is displaced by the lever 71, the pressing portion 70 having the projection shape presses the lid section 30 toward the inside of the depression 26, enabling the elastic deformation of the lid section 30. At this time, the leverage amplifies a force for pressing the lid section 30 by the pressing portion 70. The pressing member 7 is easily pressed down to the maximum stroke position to bring the lid section 30 close to the bottom portion 260 with a small operation force.

The lever 71 may have the hinge portions 711 and the holding portion 712. The hinge portions 711 may be located at one longitudinal end of the lever 71 and the holding portion 712 may be located at the other longitudinal end of the lever 71. In this case, the hinge portions 711 can function as the fulcrums, the holding portion 712 can function as the point where force is applied, and the pressing portion 70 located between the hinge portions 711 and the holding portion 712 can function as the point of action. Hence, the lever 71 can be restrained from projecting to the radially outside of the lid section 30 in a state where the pressing portion 70 faces the lid section 30, and therefore a size reduction of the dispenser 1 can be achieved. The shape of the lever 71 is not limited to the example illustrated in the figures. The fulcrums or the point where force is applied of the lever 71 are arbitrarily arranged. For example, the point where force is applied (the holding portion 712) of the lever 71 may be located on the side of the nozzle section 23 and the fulcrums (the hinge portions 711) may be located on the opposite side to the side of the nozzle section 23.

The fulcrums of the lever 71 may be positioned at a height between the opening 261 and the deepest part of the depression 26 in side view of the depression 26. In other words, the hole 710 and the projections 231 as the fulcrums of the lever 71 may be located at a height where the hole 710 and the projections 231 are superimposed on the depression 26. In this case, when the turning angles of the lever 71 from the initial position to the maximum stroke position are set to a common turning angle, the height at the initial position of the holding portion 712 of the lever 71 may be lowered, as compared with a case where the fulcrums are located at a height different from the above-described height, e.g., above or below the depression 26. In other words, the pressing portion 70 can be greatly pressed down and the lid section 30 can be brought close to the bottom portion 260 with a relatively small stroke amount of the lever 71. Hence, the enlargement of the dispenser 1 can be suppressed.

The fulcrums of the lever 71 may be located on the side of the opening 261 of the depression 26. In this case, a size reduction of the hinge portions 711 can be achieved. The fulcrums of the lever 71 may be located on the side of the nozzle section 23 and located at a height where the fulcrums of the lever 71 are superimposed on the nozzle section 23. In this case, parts continuous to the nozzle section 23 of the housing 2 can be utilized as the fulcrums for the lever 71, and therefore the complexity or the enlargement of the dispenser 1 can be suppressed.

The lever 71 and the pressing portion 70 may be integrated with each other. In this case, an input to the lever 71 can be directly transmitted to the pressing portion 70 with a simple structure. Specifically, the lever 71 and the plate portions 701 may be integrated with each other. In this case, the lever 71 can be reinforced with the plate portions 701. Specifically, the plate portions 701 may extend along the longitudinal direction of the lever 71, i.e., a straight line connecting the fulcrums and the point where force is applied of the lever 71. In this case, the plate portions 701 function as ribs suppressing the bending deformation between the fulcrums and the point where force is applied of the lever 71, so that the strength of the lever 71 can be improved and the input to the lever 71 can be efficiently transmitted to the lid section 30 through the plate portions 701.

The pressing portion 70 may include the projections 702 projecting from the tip surfaces of some of the plurality of the plate portions 701. The projections 702 project from the tip surface, i.e., the envelope surface 700, of the pressing portion 70. In this case, even when the pressing portion 70 is provided in the lever 71, the projections 702 are arranged to contact the center portion in the upper surface of the lid section 30, for example, at the initial position of the lever 71, thereby facilitating the superimposition in the turning direction of the lever 71 of the site where the pressing portion 70 presses the lid section 30 when the pressing member 7 strokes from the initial position and the site which can be pressed by the biasing unit 8 of the lid section 30. The side of the holding portion 712 of the projection 702 may have a projecting curved shape as viewed from the turning axis direction of the lever 71. In this case, the projections 702 can be stably brought into contact with the upper surface of the lid section 30 in response to the stroke of the lever 71.

As illustrated in FIGS. 8 and 9, the pressing portion 70 may be provided to allow the projections 702 to enter the inside of the biasing unit containing hole 27. In this case, the other sites at the tips of the plate portions 701, i.e., the envelope surface 700, can be brought closer to the bottom portion 260 of the depression 26. This can reduce the gap between the lid section 30, which is deformed into the shape following the envelope surface 700, and the bottom portion 260. Specifically, the height or the shape of the pressing portion 70 may be set to allow the projections 702 to enter the inside of the biasing unit containing hole 27.

### Second Embodiment

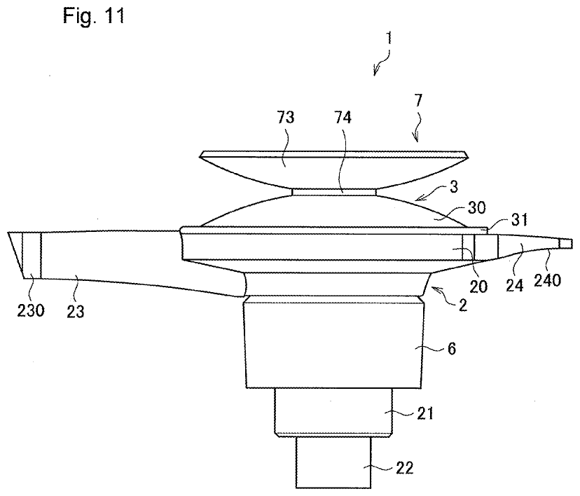

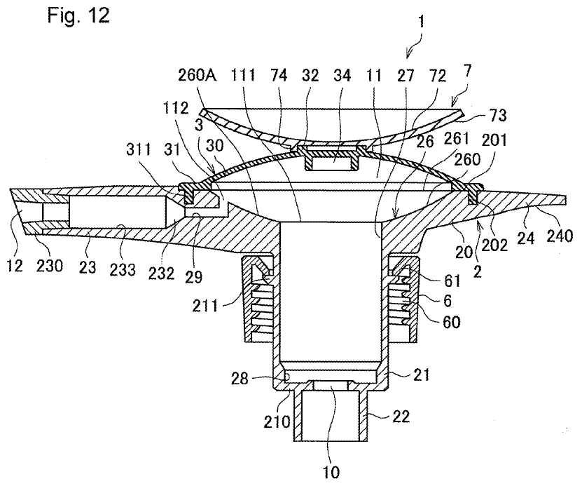

FIGS. 10 to 12 illustrate the configuration of the dispenser 1 of this embodiment. This embodiment gives an example of the dispenser 1 in which the pressing member 7 is not provided integrally with the lever, and the pressing member 7 functions as it is as the pressing portion. The same signs as those of the first embodiment are attached to the configurations common to those of the first embodiment and descriptions thereof are omitted. For simplicity, the illustration of the suction valve 4, the discharge valve 5, and the biasing unit 8 is omitted in FIG. 12.

The pressing member 7 has a watch glass shape, a circular shape in plan view, and a diameter substantially equal to the diameter of the lid section 30. The pressing member 7 has a dent 72 formed on the side of the upper surface. A lower surface 73 of the pressing member 7 faces the upper surface of the lid section 30 and functions as the pressing portion. The lower surface 73 has a shape bulging toward the lid section 30, a curved surface shape in which the spherical surface is partly cut out, and a curvature equal to that of the facing site of the bottom portion 260, for example. From a center portion of the lower surface 73, a cylindrical locking target portion 74 projects. From a center portion of the upper surface of the lid section 30, a cylindrical locking portion 32 projects. The pressing member 7 is installed at the lid section 30. The locking portion 32 of the lid section 30 is fitted to the locking target portion 74 of the pressing member 7.

A user can place a part of a hand, e.g., a finger, on the dent 72, for example, and press the pressing member 7 downward. The lid section 30 is deformed into a shape following the lower surface 73 of the pressing member 7. At the maximum stroke position, the upper surface of the lid section 30 contacts the lower surface 73 of the pressing member 7 in a range including the outer peripheral edge or the vicinity thereof of the upper surface of the lid section 30, and the entire surface of the lid section 30 can be deformed toward the inside of the depression 26. At the maximum stroke position, a gap between the lid section 30 and the bottom portion 260 of the depression 26 is minimum, and the lower surface of the lid section 30 is along the bottom portion 260.

### Third Embodiment

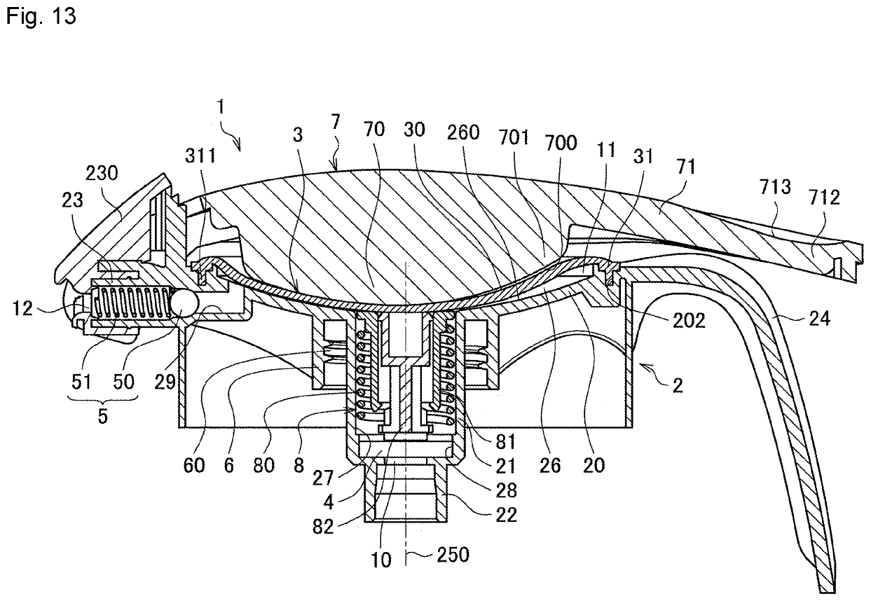

FIG. 13 is a cross-sectional view similar to FIG. 8, illustrating the configuration of the dispenser 1 of this embodiment. Hereinafter, the same signs as those of the first embodiment are attached to the configurations common to those of the first embodiment and descriptions thereof are omitted.

This embodiment gives an example of the dispenser 1 in which the curvature of the tip surface of the pressing portion 70 differs between the side of the fulcrums of the lever 71 and the side of the point where force is applied (the holding portion 712).

The lid section 30 is not provided with the locking portion 34. The mounting member 6 is provided integrally with the housing 2. The holding portion 24 of the housing 2 has a plate shape and a bent shape. The holding portion 24 has a portion extending in the radial direction of the disk section 20 and a portion bent and extending downward with respect to this portion. At the tip of the nozzle section 23, the cap 230 is installed. The hinge portions 711 of the lever 71 are turnably supported between the cap 230 and the housing 2. More specifically, the fulcrums of the lever 71 are located on the side of the nozzle section 23 with respect to the axis 250 of the disk section 20 and the like. The locking portion 34 may be provided in the lid section 30, and the mounting member 6 may be provided separately from the housing 2. The cap 230 or the fulcrums of the lever 71 may also have structures similar to those of the first embodiment.

The pressing portion 70 includes the plurality (e.g., seven) of plate portions 701. The projections 702 are not provided in the plate portions 701, but may be provided as with the first embodiment. A region on the side of the fulcrums of the lever 71 in the longitudinal direction connecting the fulcrums and the point where force is applied of the lever 71 to each other of the tip surface of each plate portion 701, i.e., the envelope surface 700, has a shape along the facing site of the bottom portion 260 and has a curvature equal to that of the facing site of the bottom portion 260. In contrast, a region on the side opposite to the fulcrums of the lever 71 in the longitudinal direction of the lever 71, in other words, a region on the side of the holding portion 712, of the envelope surface 700 has a curvature larger than that of the facing site of the bottom portion 260. In other words, the region on the side of the fulcrums of the lever 71 with respect to the axis 250 of the disk section 20 and the like of the tip surface of each plate portion 701, i.e., the envelope surface 700, has a curvature equal to that of the facing site of the bottom portion 260 at the maximum stroke position of the lever 71 illustrated in FIG. 13. In contrast, the region on the side opposite to the fulcrums of the lever 71 across the axis 250, in other words, the region on the side of the holding portion 712 with respect to the axis 250, of the envelope surface 700 has a curvature larger than that of the facing site of the bottom portion 260. As described above, the shape of the envelope surface 700, i.e., the tip surface of the pressing portion 70, is provided. Thus, the elastic deformation amount of the lid section 30 is smaller on the side far from the fulcrums of the lever 71 than on the side close to the fulcrums of the lever 71 during the stroke of the lever 71. As illustrated in FIG. 13, a gap between the lid section 30 and the bottom portion 260 of the depression 26 is minimum at the maximum stroke position of the lever 71 but a gap can arise between the lid section 30 and the bottom portion 260 in at least a partial region on the side of the holding portion 712 with respect to the axis 250.

Thus, the shape of the tip surface of the pressing portion 70, specifically the tip surface of each plate portion 701, i.e., the envelope surface 700, may be provided such that the elastic deformation amount of the lid section 30 is smaller on the side far from the fulcrums of the lever 71 than on the side close to the fulcrums of the lever 71. In this case, the reaction force transmitted from the lid section 30 to the lever 71 is further suppressed on the side far from the fulcrums of the lever 71 than on the side close to the fulcrums of the lever 71, in other words, at a site where an amplification action of a force by the lever 71 is relatively low. This can reduce an operation force for discharging the liquid material from the dispenser 1 using the lever 71.

The region on the side of the fulcrums of the lever 71 of the tip surface of the pressing portion 70 may have a curvature equal to that of the facing site of the bottom portion 260, and the region on the opposite side to the side of the fulcrums of the lever 71 may have a curvature larger than the curvature of the facing site of the bottom portion 260. In other words, the shape of the tip surface of the pressing portion 70 may be provided such that, as viewed at the maximum stroke position of the lever 71, a difference between the curvature of the tip surface of the pressing portion 70 and the curvature of the facing site of the bottom portion 260 differs between the side of the fulcrums of the lever 71 and the opposite side thereto across the axis 250. Specifically, the shape of the tip surface of the pressing portion 70 may be provided such that the above-described curvature difference is larger on the opposite side (the side of the holding portion 712 which is the point where force is applied of the lever 71) to the side of the fulcrums of the lever 71 than on the side of the fulcrums of the lever 71. This can make the elastic deformation amount of the lid section 30 pressed by the pressing portion 70 smaller on the side far from the fulcrums of the lever 71 than on the side close to the fulcrums of the lever 71 while forming the shape of the bottom portion 260 to be symmetrical with respect to the axis 250. In particular, when the plate portions 701 of the pressing portion 70 are not provided with the projections 702, the elastic deformation amount of the lid section 30 can be more reliably made smaller on the side far from the fulcrums of the lever 71.

When the above-described curvature difference is differentiated between the side of the fulcrums of the lever 71 and the opposite side thereto across the axis 250 at the maximum stroke position as described above, a gap can arise between the lid section 30 and the bottom portion 260 of the depression 26 at the maximum stroke position as illustrated in FIG. 13. The shape of the bottom portion 260 may be changed such that this gap is reduced. In other words, the elastic deformation amount of the lid section 30 can be made smaller on the side far from the fulcrums of the lever 71 than on the side close to the fulcrums of the lever 71 without differentiating the above-described curvature difference between the side of the fulcrums of the lever 71 and the opposite side thereto across the axis 250 at the maximum stroke position.

As illustrated in FIG. 13, the shape of the tip surface of the pressing portion 70 may be provided such that at least a part of the region on the opposite side to the fulcrums of the lever 71 across the axis 250 of the tip surface of the pressing portion 70 does not abut on the upper surface of the lid section 30 at the maximum stroke position of the lever 71. More specifically, the shape of the tip surface of the pressing portion 70 may be provided such that at least a part of the region on the opposite side to the fulcrums of the lever 71 of the tip surface of the pressing portion 70 is separated from the upper surface of the lid section 30. In this case, the reaction force transmitted from the lid section 30 to the lever 71 can be more effectively suppressed on the side far from the fulcrums of the lever 71 than on the side close to the fulcrums of the lever 71.

The dispenser 1 may be provided such that the lever 71 can be pressed down with a finger. For example, the housing 2 as the dispenser body may have the holding portion 24. In this case, it is easy for a user to hold the holding portion 24 of the housing 2 and the holding portion 712 of the lever 71 with one hand and press down the holding portion 712 of the lever 71 with the thumb, for example. Thus, in a case of the structure in which a user can press down the lever 71 with a force of a finger instead of the entire hand, the above-described advantage of reducing an operation force of the lever 71 by the shape of the tip surface of the pressing portion 70 can be more effectively obtained. The holding portion 24 facing the holding portion 712 of the lever 71 may be provided not in the dispenser 1 but in the container 100 attached to the dispenser 1.

Next, the dispenser (ii) is described based on the first embodiment described above. In the first embodiment, when the lever 71 is operated, i.e., the holding portion 712 of the lever 71 is pressed down from the initial position, the pressing portion 70 functions as the point of action of the lever 71 and presses the lid section 30 downward. The pressing portion 70 presses the lid section 30 to the side toward the bottom portion 260 of the depression 26, i.e., the side where the volume of the pump chamber 11 decreases, for elastic deformation.

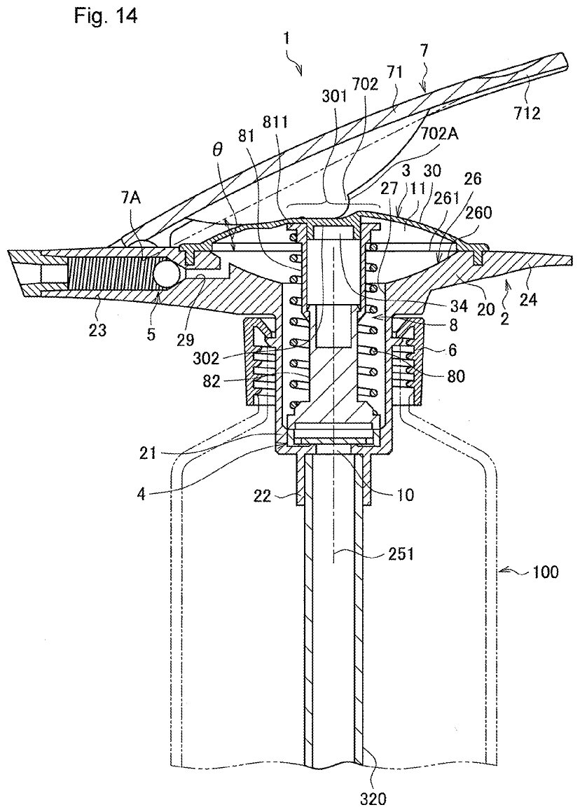

FIG. 14 illustrates the dispenser 1 when the lever 71 is pressed down from the initial position, the lid section 30 and one axial end of the biasing unit 8 (specifically, the first flange portion 811 of the first support 81 described later) abut on each other in response to the elastic deformation of the lid section 30 by the pressing by the pressing portion 70, and the biasing unit 8 starts to press a predetermined site 301 of the inner surface of the lid section 30 in response to the elastic deformation of the lid section 30. The position of the lever 71 at this time is referred to as a biasing start position. A line segment connecting the fulcrum 7A of the lever 71 and the holding portion 712 as the point where force is applied has an angle θ larger than zero with respect to the opening 261 of the depression 26 at the biasing start position.

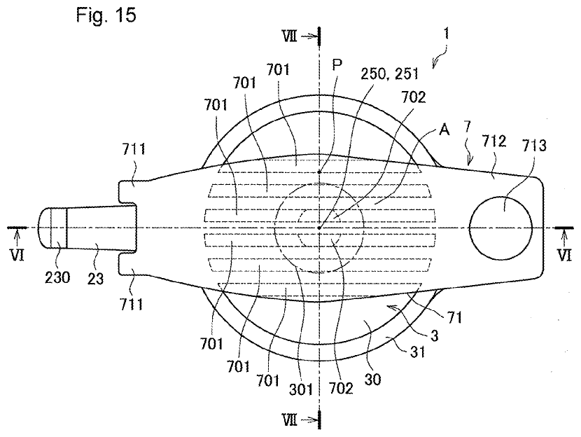

In the turning direction of the lever 71, the tips of the pressing portion 70 i.e., the plurality of plate portions 701, abut on a part of the lid section 30. A region including the tips of the pressing portion 70 in plan view of the lever 71 is defined as the region A (see FIG. 15). At the biasing start position illustrated in FIG. 14, a part of the region A is located on the side of the fulcrum 7A relative to the site 301 of the lid section 30. As illustrated in FIG. 15, the dimension of the region A in the longitudinal direction of the lever 71 is substantially equal to the dimension of the lid section 30 in the longitudinal direction of the lever 71 at the maximum stroke position. At the maximum stroke position, the outer edge of the region A in the longitudinal direction of the lever 71 is superimposed on the outer peripheral edge of the lid section 30. The dimension of the region A in the plate width direction perpendicular to the longitudinal direction of the lever 71 is larger than the radius of the lid section 30. When a point equidistant from both the outer peripheral edge and the center portion in the lid section 30 is defined as the midpoint P, the outer edge of the region A in the plate width direction of the lever 71 is located on the outer peripheral edge side relative to the midpoint P of the lid section 30. The above-described center portion of the lid section 30 may be located at or near the intersection with the axis 251 of the depression 26 and the like.

The first support 81, the second support 82, and the coil spring 80 have a common axis 83 and extend along the axis 83. As illustrated in FIG. 5, when the biasing unit 8 is installed inside the housing 2 and the lever 71 is located at the initial position, the above-described axis 83 of the coil spring 80 and the like, in other words, the axis 83 of the biasing unit 8, is aligned with the axis 251 of the biasing unit containing hole 27 and the like. The maximum value of the axial dimension of the biasing unit 8 is set such that the biasing unit 8 does not press the lid section 30 upward in this state. For example, when the lever 71 is located at the initial position, there is a gap between the first flange portion 811 of the first support 81 and the lid section 30 in the turning direction of the lever 71, and the first flange portion 811 is provided not to abut on the lid section 30. At the initial position, there may be a gap between the pressing portion 70 and the lid section 30.

When the lever 71 is pressed down from the initial position to the biasing start position, the inner surface of the lid section 30 abuts on the first flange portion 811 of the first support 81. In response to the elastic deformation of the lid section 30 by the pressing by the pressing portion 70, the biasing unit 8 can press the predetermined site 301 of the lid section 30 by an elastic force generated in the coil spring 80 to be pressed and contracted. When the first flange portion 811 is projected to the lid section 30 in the turning direction of the lever 71, the site 301 is a region surrounded by the outer edge of the above-described projected portion of the first flange portion 811 in the lid section 30. As illustrated in FIG. 15, the site 301 is located on the side of the center portion relative to the outer peripheral edge in the lid section 30. Specifically, the site 301 is located on the side of the center portion relative to the midpoint P in the lid section 30. As illustrated in FIGS. 9, 14 and 15, the site 301 overlaps an end portion in the axial direction, i.e., elasticizing direction, of the biasing unit 8 in the turning direction of the lever 71. Specifically, the site 301 faces the first flange portion 811 of the first support 81 and is superimposed on an axial end portion of the coil spring 80 in the turning direction of the lever 71. While the biasing unit 8 is pressing the lid section 30 between the biasing start position and the maximum stroke position, a site 302 pressed by the pressing portion 70 and the site 301 of the lid section 30 are superimposed on each other. More specifically, both the sites 301 and 302 are provided to overlap each other in the turning direction of the lever 71 or in plan view of the lid section 30.

Next, advantages of the above-described configurations are described. The biasing unit 8 is arranged inside the housing 2 as the dispenser body and can press the inner surface of the lid section 30. Even when the lid section 30 is deformed from the initial state by being pressed by the pressing portion 70, the lid section 30 is biased toward the biasing start position not only by the elastic force of the lid section 30 but by the biasing unit 8. Hence, the lid section 30 can be more reliably and quickly returned to the initial state. For example, even when the viscosity of a liquid is so high that the return of the lid section 30 to the initial state is unreliable or slow only by the elastic force of the lid section 30, the lid section 30 can be easily returned to the initial state by providing the biasing unit 8.

When the diameter of the pump chamber 11 is increased as described above, a relatively large force is required to deform the lid section 30 to reduce the volume of the pump chamber 11. When the biasing unit 8 is installed, a pressing force is additionally required to reduce the volume of the pump chamber 11 against the force of the biasing unit 8. In contrast, the pressing portion 70 capable of pressing the outer surface of the lid section 30 is provided in the lever 71. The lever 71 is provided rotatably with respect to the housing 2. Hence, a large pressing force of the pressing portion 70 can be obtained with a small operation force by the leverage. This can easily deform the lid section 30 to reduce the volume of the pump chamber 11. For example, the lid section 30 can be easily brought close to the bottom portion 260, the volume change amount of the pump chamber 11 can be easily increased, and the dischargeable amount from the pump chamber 11 can be easily increased. The shape of the lever 71 is not limited to the example illustrated in the figures. The fulcrums or the point where force is applied of the lever 71 are/is arbitrarily arranged. For example, the point where force is applied of the lever 71 (the holding portion 712) may be located on the side of the nozzle section 23 and the fulcrums may be located on the opposite side to the side of the nozzle section 23.

When the pressing portion 70 is provided in the lever 71, there is a risk that a pressed site of the outer surface of the lid section 30 by the pressing portion 70, i.e., the site 302 pressed by the pressing portion 70 of the lid section 30, is deviated from a pressed site of the inner surface of the lid section 30 by the biasing unit 8, i.e., the site 301 pressed by the biasing unit 8 of the lid section 30. In this case, there is a risk that a force is only indirectly input to the biasing unit 8 from the pressing portion 70 through the lid section 30 to be elastically deformed, and thus the biasing unit 8 does not smoothly operate and the original function thereof is not sufficiently exhibited. Further, there is a risk that the biasing unit 8 does not smoothly operate due to the deviation of the operation direction of the biasing unit 8 from a desired direction. Further, there is a risk that the deviation of the operation direction of the biasing unit 8 from a desired direction increases a risk that the biasing unit 8 interferes with the housing 2, and this interference further hinders the smooth operation of the biasing unit and lowers the durability of the dispenser 1.

In contrast, in the dispenser 1 of this embodiment, the pressing portion 70 and the biasing unit 8 are provided such that, when the biasing unit 8 starts to press the inner surface of the lid section 30 in response to the elastic deformation of the lid section 30 by the pressing by the pressing portion 70 after the lever 71 starts to stroke from the initial position, the pressed site 302 of the outer surface of the lid section 30 by the pressing portion 70 and the pressed site 301 of the inner surface of the lid section 30 by the biasing unit 8 are superimposed on each other. Hence, a site superimposed on the pressed site 301 by the biasing unit 8 of the lid section 30 is pressed by the pressing portion 70 at least at the biasing start position, and therefore a force is more directly input to the biasing unit 8 from the pressing portion 70. Further, the operation direction of the biasing unit 8 is easily set to a direction along a desired direction. This allows the smooth operation of the biasing unit 8. Further, the risk that the biasing unit 8 interferes with the housing 2 is reduced, and therefore the smooth operation of the biasing unit 8 can be promoted and the reduction in the durability of the dispenser 1 can be suppressed. Further, the lid section 30 is easily elastically deformed into a desired form.

The pressed site 302 by the pressing portion 70 and the pressed site 301 by the biasing unit 8 of the lid section 30 may be provided to be superimposed on each other while the lever 71 is being pressed downward relative to the biasing start position and the biasing unit 8 is pressing the lid section 30. In this case, the site superimposed on the pressed site 301 by the biasing unit 8 of the lid section 30 is pressed by the pressing portion 70 in the entire range in which the biasing unit 8 is operable. Hence, the biasing unit 8 can be more smoothly operated.

The biasing unit 8 may have the coil spring 80 as the biasing member capable of generating a biasing force for pressing the inner surface of the lid section 30. By the use of the coil spring 80 as the biasing member as described above, a stable pressing force against the deformation of the lid section 30 can be easily obtained. The biasing unit 8 may have a plate spring or the like as the biasing member without being limited to the coil spring.

At the biasing start position, the pressed site 302 of the outer surface of the lid section 30 by the pressing portion 70 and the axial end portion of the coil spring 80 facing the inner surface of the lid section 30 may be provided to be superimposed on each other. In this case, a force is more directly input to the axial end portion of the coil spring 80 from the pressing portion 70 at least at the biasing start position. The elastic deformation direction of the coil spring 80 is easily set to a direction along a desired operation direction. This enables smooth elastic deformation of the coil spring 80 and enables stable generation of the pressing force by the biasing unit 8. Further, the elastic deformation direction of the coil spring 80 is set to a direction along the axis 251 of the biasing unit containing hole 27, for example, thereby reducing the risk that the coil spring 80 interferes with the housing 2. Therefore, a smooth operation of the coil spring 80 can be promoted and the reduction in the durability of the dispenser 1 can be suppressed. From such a viewpoint, the above-described site 302 and the axis 83 of the coil spring 80 may be provided to be superimposed on each other at the biasing start position.

While the biasing unit 8 is pressing the lid section 30, the pressed site 302 of the outer surface of the lid section 30 by the pressing portion 70 and the axial end portion of the coil spring 80 may be provided to be superimposed on each other. In this case, the axial end portion of the coil spring 80 is directly pressed by the pressing portion 70 in the entire range where the biasing unit 8 is operable. Hence, the biasing unit 8 can be more smoothly operated.

The coil spring 80 may be in a normally compressed state. In other words, also when the biasing unit 8 has the maximum length, the coil spring 80 may be in the pressed and contracted state. In this case, the biasing force by the elastic force of the coil spring 80 can be generated and the lid section 30 can be pressed in the entire stroke range of the biasing unit 8. Hence, even in a state where the lid section 30 is returned to the vicinity of the biasing start position, the coil spring 80 can generate the biasing force, and therefore the function of the biasing unit 8 of returning the lid section 30 toward the initial state can

$$be improved .$$

The biasing unit 8 may have the first support 81 and the second support 82 supporting the coil spring 80, and the first support 81 and the second support 82 may be slidable with respect to each other along the axial direction of the coil spring 80. These supports 81 and 82 are movable relative to each other along the common axis 83 and can be freely elasticized by sliding with respect to each other, for example. In this case, due to the fact that both the supports 81 and 82 guide the coil spring 80 while holding it such that the coil spring 80 is elasticized in the axial direction, the coil spring 80 can be smoothly elastically deformed. This enables the stable generation of the pressing force by the biasing unit 8. The biasing unit 8 may have only the coil spring 80 as the biasing member instead of having the supports 81 and 82.

At the biasing start position, the pressed site 302 of the outer surface of the lid section 30 by the pressing portion 70 and the axial end portion (the first flange portion 811) of the first support 81 facing the inner surface of the lid section 30 of the support 81 and the second support 82 may be provided to be superimposed on each other. In this case, a force is more directly input to the axial end portion of the support 81 from the pressing portion 70 at least at the biasing start position. The sliding direction of both the supports 81 and 82 is easily set to a direction along a desired operation direction, e.g., the axis 83. This enables the smooth sliding of both the supports 81 and 82 and the stable generation of the pressing force by the biasing unit 8. Further, a risk that both the supports 81 and 82 are tilted to interfere with the housing 2 is reduced, and therefore the smooth operation of the biasing unit 8 can be promoted and the reduction in the durability of the dispenser 1 can be suppressed. From such a viewpoint, the above-described site 302 and the axis 83 of both the supports 81 and 82 may be provided to be superimposed on each other at the biasing start position.

While the biasing unit 8 is pressing the lid section 30, the pressed site 302 of the outer surface of the lid section 30 by the pressing portion 70 and the axial end portion (the first flange portion 811) of the first support 81 facing the inner surface of the lid section 30 of the support 81 and the second support 82 may be provided to be superimposed on each other. In this case, the axial end portion of the support 81 is directly pressed by the pressing portion 70 in the entire range where the biasing unit 8 is operable. Hence, the biasing unit 8 can be more smoothly operated.

The coil spring 80 may be installed to be wound around the outer periphery of the first and second supports 81 and 82. In this case, the degree of freedom of design of the coil spring 80 is higher, e.g., the diameter of the coil spring 80 can be increased, than that when the coil spring 80 is installed inside the first and second supports 81 and 82, and therefore a stable pressing force of the biasing unit 8 can be more simply obtained.

The axis 83 of the coil spring 80 or the axis 83 of the first and second supports 81 and 82 may be arranged in a direction along the track of the pressing portion 70 accompanied by the stroke of the lever 71. In this case, the elastic deformation direction of the coil spring 80 or the sliding direction of both the supports 81 and 82 is more easily set to a desired operation direction, e.g., a direction along the axis 83.

The biasing unit 8 may be provided not to press the lid section 30 in the initial state before the lid section 30 is elastically deformed by the pressing portion 70. In this case, it is avoided that the lid section 30 is pressed and brought into a normally deformed state also when the lever 71 is not operated. This can suppress the plastic deformation or the reduction in the durability of the lid section 30. In other words, the pressing by the biasing unit 8 may not be considered in the initial state, and therefore the degree of freedom of design of mechanical properties or thickness of the lid section 30 can be improved.

Specifically, the maximum length of the biasing unit 8 may be limited to such a size that the lid section 30 is not pressed in the initial state before the lid section 30 is elastically deformed by the pressing portion 70. Herein, the maximum length of the biasing unit 8 may be provided to be limited by the biasing unit 8 itself. In this case, a structure for regulating the maximum length of the biasing unit 8 may not be provided on the side of the housing 2, and therefore the complexity of the dispenser 1 can be suppressed. Further, the assemblability of the biasing unit 8 to the housing 2 can be improved.

Specifically, the first support 81 and the second support 82 may be provided to be engageable with each other in a direction where the biasing unit 8 stretches. In this case, due to the fact that the above-described engagement regulates the relative movement between both the supports 81 and 82, the maximum length of the biasing unit 8 can be limited by the biasing unit 8 itself. Further, both the supports 81 and 82 can hold the coil spring 80 in a normally compressed state.

The lid section 30 may have the locking portion 34 on the side of the pump chamber 11. In other words, the locking portion 34 may be provided on the inner surface of the lid section 30. In this case, the axial end portion (the first flange portion 811) as a part of the biasing unit 8 is locked with the locking portion 34, thereby suppressing the deviation of the biasing unit 8 from the lid section 30. Hence, the deviation in the operation direction of the biasing unit 8 can be suppressed and the interference between the housing 2 and the biasing unit 8 can be suppressed during the elastic deformation of the lid section 30. Further, due to the fact that a part of the lid section 30 also serves as the locking portion 34, an increase in the number of parts can be suppressed and a size reduction of the dispenser 1 can be achieved.

The lid section 30 may be provided to cover the opening 261 of the depression 26 of the housing 2 and may have a shape projecting upward, i.e., the side away from the depression 26, with respect to the opening 261 of the depression 26 in the initial state. In this case, a large volume of the pump chamber 11 in the initial state is easily secured. Further, the deformation amount from the initial state of the lid section 30, i.e., the volume change amount of the pump chamber 11, can be increased and the dischargeable amount from the pump chamber 11 can be increased. Further, the distance from the bottom portion 260 of the depression 26 to the lid section 30 increases, and the deformation amount of the biasing unit 8 can be correspondingly increased. This increases a risk that the elastic deformation direction of the biasing unit 8 is deviated from a desired operation direction or that the biasing unit 8 interferes with the housing 2. Hence, the above-described effect obtained by superimposing the pressed site 302 of the outer surface of the lid section 30 by the pressing portion 70 and the pressed site 301 of the inner surface of the lid section 30 by the biasing unit 8 on each other can be improved. The lid section 30 is formed into an arbitrary shape and may have a flat surface shape expanding along the upper surface 201 of the disk section 20 or may have a shape projecting downward with respect to the opening 261 of the depression 26, i.e., the side approaching the bottom portion 260 of the depression 26. The lid section 30 may also be formed of an elastic material.

The lid section 30 may have a bulging portion bulging to the opposite side to the side of the depression 26. In other words, the lid section 30 may have a bulging portion bulging upward, i.e., to the side away from the depression 26 (e.g., a dome-like portion) in the initial state. This bulging portion may form a part or the entire of the lid section 30. The pressed site 301 of the inner surface of the lid section 30 by the biasing unit 8 may be located in the above-described bulging portion. The pressed site of the outer surface of the lid section 30 by the pressing portion 70 at the biasing start position may be located in the above-described bulging portion. In this case, when the above-described bulging portion is deformed from the initial state, the bulging direction of the above-described bulging portion is reversed from the side away from the bottom portion 260 of the depression 26 to the side toward the bottom portion 260. Hence, the volume change amount of the pump chamber 11 can be efficiently increased and the dischargeable amount from the pump chamber 11 can be efficiently increased. Meanwhile, the range of the pressing portion 70 abutting on the above-described bulging portion at the biasing start position can be narrowed due to the bulging shape of the above-described bulging portion. When the line segment connecting the fulcrum 7A and the point where force is applied (the holding portion 712) of the lever 71 has an angle θ larger than zero with respect to the opening 261 of the depression 26 at the biasing start position, a site pressed by the pressing portion 70 at the biasing start position of the above-described bulging portion is easily separated and easily deviated from the pressed site 301 of the inner surface of the lid section 30 by the biasing unit 8. Hence, the above-described effect obtained by superimposing the pressed site 302 by the pressing portion 70 and the pressed site 301 by the biasing unit 8 on each other can be improved. From such a viewpoint, the pressing portion 70 and the biasing unit 8 may be provided such that, when the biasing unit 8 starts to press the inner surface of the bulging portion in response to the elastic deformation of the bulging portion by the pressing by the pressing portion 70, the pressed site 302 of the outer surface of the above-described bulging portion by the pressing portion 70 and the pressed site 301 of the inner surface of the above-described bulging portion by the biasing unit 8 are superimposed on each other.

At the biasing start position, a part of the pressing portion 70 may be located on the side of the fulcrum 7A relative to the pressed site 301 of the inner surface of the lid section 30 by the biasing unit 8. In this case, there is a high risk that the pressed site of the outer surface of the lid section 30 by the pressing portion 70 is located on the side of the fulcrum 7A relative to the pressed site 301 of the inner surface of the lid section 30 by the biasing unit 8 at the biasing start position, in other words, easily separated and easily deviated from the pressed site 301. Hence, the above-described effect obtained by superimposing the pressed site 302 by the pressing portion 70 and the pressed site 301 by the biasing unit 8 on each other can be improved.

The pressed site 301 of the inner surface of the lid section 30 by the biasing unit 8 may be located on the side of the center portion relative to the outer peripheral edge in the lid section 30. In this case, the maximum stroke amount of the biasing unit 8 is easily increased or the axis 83 of the biasing unit 8 is easily arranged along the axis 251 of the depression 26 and the like. Further, the biasing unit 8 can effectively press the entire of the lid section 30, and thus the lid section 30 can be smoothly returned toward the initial position. Meanwhile, when the line segment connecting the fulcrum 7A and the point where force is applied (the holding portion 712) of the lever 71 has an angle θ larger than zero with respect to the opening 261 of the depression 26 at the biasing start position, the pressed site of the outer surface of the lid section 30 by the pressing portion 70 is located on the outer peripheral edge side relative to the center portion of the lid section 30 at the biasing start position, and thus is easily separated and easily deviated from the pressed site 301 of the inner surface of the lid section 30 by the biasing unit 8. Hence, the above-described effect obtained by superimposing the pressed site 302 by the pressing portion 70 and the pressed site 301 by the biasing unit 8 on each other can be improved. Further, when the pressed site 302 of the lid section 30 by the pressing portion 70 and the pressed site 301 by the biasing unit 8 located on the side of the center portion of the lid section 30 are superimposed on each other at the biasing start position, the pressing portion 70 presses the side of the center portion of the lid section 30 at least at the biasing start position. Hence, the twisting between the pressing portion 70 and the lid section 30 can be suppressed and the lid section 30 can be smoothly elastically deformed.

The tips of the pressing portion 70 facing the lid section 30 may have the envelope surface 700 as a projecting surface projecting toward the lid section 30. In this case, the above-described projecting surface can increase the volume change of the pump chamber 11. For example, the pressing portion 70 easily enters the inside of the depression 26. More specifically, the lid section 30 can be deformed following the shape of the envelope surface 700. Hence, the lid section 30 is positioned inside the depression 26 and brought close to the bottom portion 260, and thus the volume change amount of the pump chamber 11 can be increased and the dischargeable amount from the pump chamber 11 can be increased. Meanwhile, in the case of a configuration in which the envelope surface 700 as the projecting surface contacts the lid section 30, the range of the tips abutting on the lid section 30 at the biasing start position of the pressing portion 70 can be narrowed. Hence, at the biasing start position, the pressed site of the outer surface of the lid section 30 by the pressing portion 70 is easily separated and easily deviated from the pressed site 301 of the inner surface of the lid section 30 by the biasing unit 8. Therefore, the above-described effect obtained by superimposing the pressed site 302 by the pressing portion 70 and the pressed site 301 by the biasing unit 8 on each other can be improved.

The pressing portion 70 may have a stripe-shaped irregular shape, i.e., the plurality of plate portions 701. In this case, the pressing portion 70 can be reduced in thickness and a difference in the thickness between each site in the pressing member 7 can be reduced. Hence, when the pressing member 7 is formed of a resin, shrinkage, i.e., a reduction in the thickness, can be suppressed and the moldability can be improved. The plate portions 701 may extend along the longitudinal direction of the lever 71, i.e., a straight line connecting the fulcrum 7A and the point where force is applied (the holding portion 712) of the lever 71. In this case, the plate portions 701 function as ribs suppressing the bending deformation between the fulcrum 7A and the point where force is applied of the lever 71, and thus the strength of the lever 71 can be improved and the input to the lever 71 can be efficiently transmitted to the lid section 30 through the plate portions 701. The pressing portion 70 may have a single projection projecting toward the side of the lid section 30 instead of having the stripe-shaped irregularities.

The fulcrum 7A of the lever 71 may be positioned at a height between the opening 261 and the deepest part of the bottom portion 260 of the depression 26 in side view of the depression 26. In this case, when the turning angles of the lever 71 from the initial position to the maximum stroke position are set to a common turning angle, the height at the initial position of the holding portion 712 of the lever 71 may be lowered, as compared with a case where the fulcrum 7A is positioned at a height different from the above-described height. Further, as compared with a case where the fulcrum 7A is located below the bottom portion 260 of the depression 26, the stroke direction of the pressing portion 70, which is the point of action, is along the elastic deformation direction of the lid section 30, in other words, the operation direction of the biasing unit 8. Hence, the twisting between the pressing portion 70 and the lid section 30 can be suppressed, and the operation of the biasing unit 8 can be smoothened. Meanwhile, as compared with a case where the fulcrum 7A is located above the opening 261 of the depression 26, the configuration of the lever 71 can be made compact.

The pressing portion 70 may have the projections 702 projecting from the envelope surface 700 as the projecting surface. In this case, irrespective of the position of the pressed site 301 of the inner surface of the lid section 30 by the biasing unit 8, the shape or the position of the projections 702 is adjusted, and thus the pressed sites of the lid section 30 by the projections 702 can be superimposed on the pressed site 301 of the inner surface of the lid section 30 by the biasing unit 8 at the biasing start position. Hence, the degree of freedom of position of the pressed site 301 by the biasing unit 8 can be improved. With the improvement, the degree of freedom of layout of the biasing unit 8 with respect to the housing 2 can be improved. For example, the pressed site 301 is easily arranged on the side of the center portion relative to the outer peripheral edge in the lid section 30. Further, the pressed sites by the projections 702 can be superimposed on the pressed site 301 by the biasing unit 8 at the biasing start position while forming the envelope surface 700 into an arbitrary shape. Hence, the degree of freedom of shape of the envelope surface 700 can be improved, and, for example, the envelope surface 700 can be formed into such a shape that the liquid material can be efficiently discharged from the pump chamber 11. For example, the shape of the envelope surface 700 can be formed into a shape corresponding to the bottom portion 260 of the depression 26, so that a gap between the lid section 30 and the bottom portion 260 at the maximum stroke position can be reduced. Further, the projections 702 are provided on the side of the pressing portion 70, and thus a change in the thickness of the lid section 30 can be reduced as compared with a case where the projections are provided on the side of the lid section 30. This can smoothen the elastic deformation of the lid section 30 and suppress a stress concentration in the lid section 30.

The portion 702A on the side of the holding portion 712 of the projection 702 may have a projecting curved shape as viewed from the fulcrum 7A, i.e., the turning axis direction, of the lever 71. In this case, the above-described portion 702A of the projection 702 can be stably brought into contact with the outer surface of the lid section 30 in response to the stroke of the lever 71. Hence, the pressed site 302 of the outer surface of the lid section 30 by the projections 702 and the pressed site 301 of the inner surface of the lid section 30 by the biasing unit 8 can be stably superimposed on each other during the operation of the biasing unit 8.

A projection may be provided on the side of the lid section 30 instead of providing the projections 702 on the side of the pressing portion 70 or together with the projections 702. More specifically, the lid section 30 may have a projection projecting from the outer surface of the lid section 30 at a position superimposed on the pressed site 301 of the inner surface of the lid section 30 by the biasing unit 8. In this case, the above-described projection and the pressing portion 70 are arranged to abut on each other at least at the biasing start position, and thus a pressed site by the pressing portion 70 in the outer surface of the lid section 30 can be superimposed on the pressed site 301 of the inner surface of the lid section 30 by the biasing unit 8. Further, the degree of freedom of shape of the side of the pressing portion 70, e.g., the envelope surface 700, can be improved.

The housing 2 may have the biasing unit containing hole 27 opened to the bottom portion 260 of the depression 26 and capable of containing a part of the biasing unit 8. In this case, the biasing unit 8 is contained in the biasing unit containing hole 27, and thus a large dimension in the operation direction of the biasing unit 8 can be secured, making it possible to easily obtain a moderate pressing force by the biasing unit 8. Further, the biasing unit 8 can be easily supported inside the housing 2.

As illustrated in FIGS. 8 and 9, the pressing portion 70 may be provided to press the lid section 30 for elastic deformation, thereby allowing a part of the lid section 30 to enter the inside of the biasing unit containing hole 27. In this case, the entering of a part of the lid section 30 into the biasing unit containing hole 27 reduces a gap between the other part of the lid section 30 and the bottom portion 260 of the depression 26. This can efficiently increase the volume change amount of the pump chamber 11.

The above-described part of the lid section 30 may include the locking portion 34. Specifically, the locking portion 34 is located at a position facing, in the turning direction of the lever 71, the opening of the biasing unit containing hole 27 in the bottom portion 260 of the depression 26. The outer diameter of the locking portion 34 is smaller than the diameter of the opening of the biasing unit containing hole 27. The height or the shape of the pressing portion 70 may be set to allow the locking portion 34 to enter the inside from the opening of the biasing unit containing hole 27. In this case, the gap between the lid section 30 and the bottom portion 260 is suppressed from increasing due to the interruption by the locking portion 34, and therefore the above-described gap at the maximum stroke can be reduced, for example.

The pressing portion 70 may be provided to press the lid section 30 for elastic deformation, thereby allowing the projections 702 to enter the inside of the biasing unit containing hole 27. In this case, the envelope surface 700 can be brought closer to the bottom portion 260 of the depression 26. This can further reduce a gap between the lid section 30, which is deformed into a shape following the envelope surface 700, and the bottom portion 260. Specifically, the height or the shape of the pressing portion 70 may be set to allow the projections 702 to enter the inside of the biasing unit containing hole 27.

### Fourth Embodiment

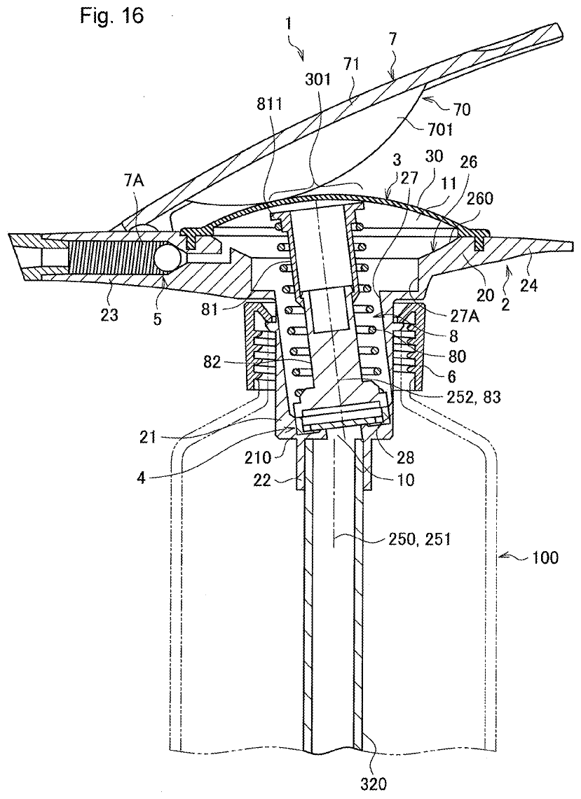

FIG. 16 is a cross-sectional view similar to FIG. 5 when the lever 71 is located at the initial position, illustrating the configuration of the dispenser 1 of this embodiment. This embodiment gives an example of the dispenser 1 in which the pressing portion 70 of the pressing member 7 does not have the projections 702, and the axis 83 of the biasing unit 8 is arranged to be tilted with respect to the axis 251 of the depression 26. The same signs as those of the first embodiment are attached to the configurations common to those of the first embodiment and descriptions thereof are omitted.

An axis 252 of the biasing unit containing hole 27, the suction valve containing hole 28, and the suction port 10 is tilted with respect to the axis 250 of the disk section 20 and the like and the axis 251 of the depression 26 and the like. The axis 83 of the biasing unit 8 is aligned with the axis 252 of the biasing unit containing hole 27 and the like. The biasing unit containing hole 27 is continuous to the depression 26 through a large diameter portion 27A. The large diameter portion 27A has a cylindrical shape coaxial with the depression 26 and is opened to the bottom portion 260 of the depression 26. The inner surface of the lid section 30 is not provided with the locking portion 34. At the initial position of the lever 71, the tip of each of two plate portions 701 located on the center side in the plate width direction of the lever 71 abuts on the side of the fulcrum 7A of the lever 71 relative to the center portion in the outer surface of the lid section 30.

Due to the fact that the axis 83 of the biasing unit 8 is tilted with respect to the axes 250 and 251, the pressed site 301 of the inner surface of the lid section 30 by the biasing unit 8 is located on the side of the fulcrum 7A relative to the center portion in the inner surface of the lid section 30. Hence, when the biasing unit 8 starts to press the inner surface of the lid section 30 in response to the elastic deformation of the lid section 30 by the pressing by the pressing portion 70 and while the biasing unit 8 is then pressing the inner surface of the lid section 30, the pressed site of the outer surface of the lid section 30 by the pressing portion 70 and the pressed site 301 of the inner surface of the lid section 30 by the biasing unit 8 are superimposed on each other.

Further, the axis 83 of the biasing unit 8 is tilted with respect to the axes 250 and 251, and therefore the axis 83 of the biasing unit 8 is easily located along the track of the pressing portion 70, i.e., the turning direction of the lever 71, accompanied by the stroke of the lever 71.

### Fifth Embodiment

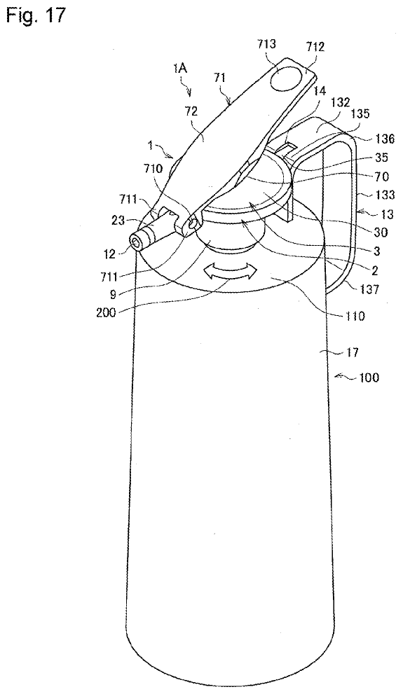

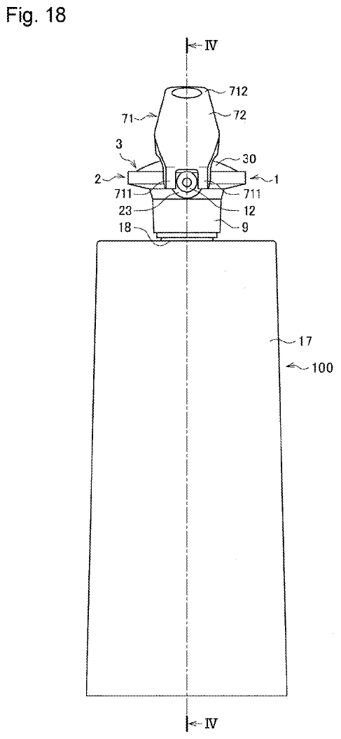

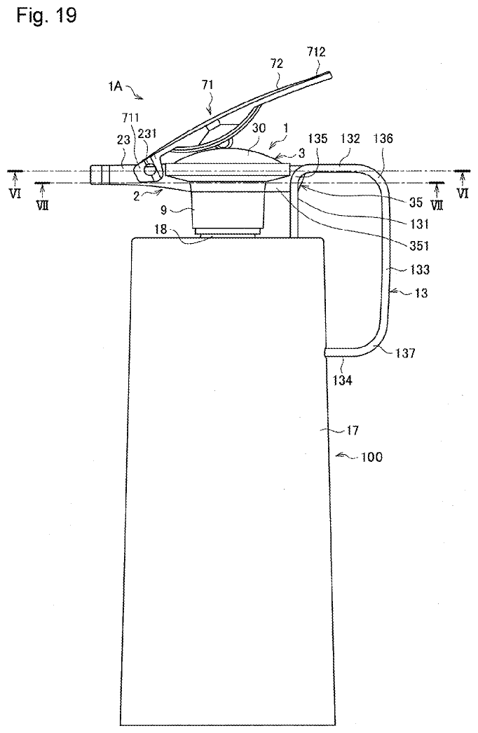

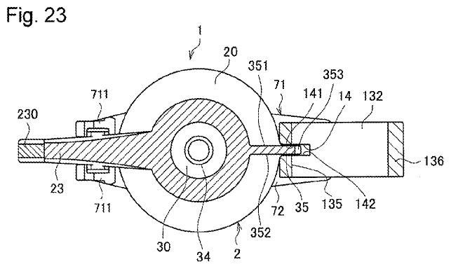

Next, the discharge container (iii) is described based on a fifth embodiment. FIGS. 17 to 23 illustrate the configuration of a discharge container 1A of this embodiment. The discharge container 1A is a device capable of discharging the liquid material from the discharging opening 12 in response to an extraction operation of a user. The description of the first embodiment described above is applicable to the liquid material. As illustrated in FIGS. 17 to 20, the discharge container 1A has the container 100, the dispenser 1, and a fixing member 9.

As illustrated in FIGS. 17, 19 and 20, the container 100 has a containing section 17, a mounting target section 18, a handle section 13, and an engagement target section 14. In the container 100, each part may be integrally molded using a synthetic resin, for example, as a material.

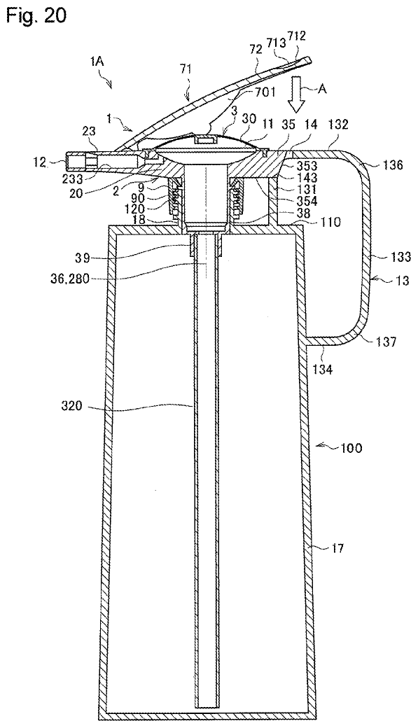

The containing section 17 has a bottle shape, for example, and can contain the liquid material. The mounting target section 18 is a mouth/neck section of the containing section 17, has a cylindrical shape, and is provided with a threaded portion 120 on the outer periphery. The mounting target section 18 projects upward from an upper surface 110 of the containing section 17. As illustrated in FIG. 20, the containing section 17 and the mounting target section 18 have a common axis 280. Hereinafter, the side of the mounting target section 18 is also referred to as “top” with respect to the containing section 17 and the side of the containing section 17 is also referred to as “bottom” with respect to the mounting target section 18 in a direction along the axis 280. However, the terms “top” and “bottom” refer to the relative positional relationship in the container 100 and do not necessarily mean the “top” and the “bottom” in the vertical direction.

The handle section 13 projects upward from the outer surface of the container 100, specifically the upper surface 110 of the containing section 17 (i.e., the same side as the mounting target section 18). The handle section 13 has a shape in which a plate is bent into an annular shape or a tubular shape and has a first flat surface portion 131, a second flat surface portion 132, a third flat surface portion 133, and a fourth flat surface portion 134 and has a first curved surface portion 135, a second curved surface portion 136, and a third curved surface portion 137 connecting each of these flat surface portions to each other. The first flat surface portion 131 and the third flat surface portion 133 expand perpendicularly with respect to the upper surface 110 of the containing section 17. The second flat surface portion 132 and the fourth flat surface portion 134 expand parallel to the upper surface 110. The first flat surface portion 131 extends upward from the upper surface 110 of the container 100. The fourth flat surface portion 134 extends from the outer peripheral surface of the container 100 to the radially outside of the container 100.

The first curved surface portion 135 connects the first flat surface portion 131 and the second flat surface portion 132, the second curved surface portion 136 connects the second flat surface portion 132 and the third flat surface portion 133, and the third curved surface portion 137 connects the third flat surface portion 133 and the fourth flat surface portion 134. The handle section 13 may have a shape of having only the curved surface portions without the flat surface portions or may have only the first flat surface portion 131 on the inner side or the second flat surface portion 132 on the upper side as the flat surface portions and have the other portions formed by the curved surface portions.

The engagement target section 14 is a depression provided in the first curved surface portion 135 of the handle section 13 and penetrates through the first curved surface portion 135. The engagement target section 14 is located in the center in the plate width direction of the first curved surface portion 135 and has a slit shape which is thin and long in the circumferential direction of the handle section 13. As illustrated in FIGS. 20, 22 and 23, the engagement target section 14 has inner surfaces 141 and 142 facing each other in the circumferential direction (direction 200 indicated by the arrows of FIG. 17) of the mounting target section 18 and an inner surface 143 interposed between both the surfaces 141 and 142 at the lower end of the engagement target section 14 and facing upward. The lower end of the engagement target section 14 is specifically positioned in a connection portion between the first curved surface portion 135 and the first flat surface portion 131.

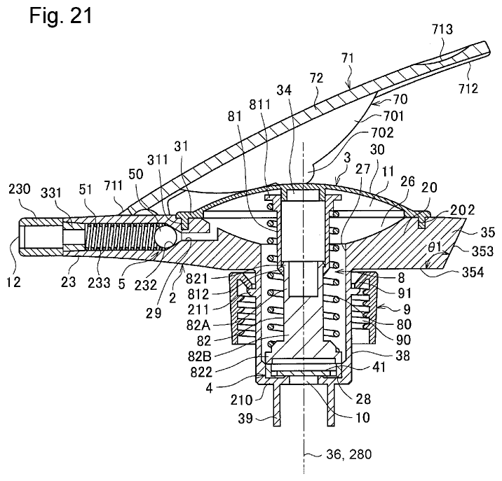

The dispenser 1 illustrated in FIG. 21 is mounted to the mounting target section 18 of the container 100 and can discharge the liquid material from the containing section 17 of the container 100 in response to an extraction operation of a user. The dispenser 1 is a so-called pump dispenser and can be provided with the same configurations as those of the dispensers according to the first to fourth embodiments described above, for example. In the dispenser 1 of this embodiment, the same signs as those of the dispensers according to the first to fourth embodiments are attached to the same configurations as those of the dispensers according to the first to fourth embodiments and descriptions thereof are omitted.

The dispenser body 2 has the disk section 20, a mounting section 38, a fitting target section 39, the nozzle section 23, and an engagement section 35. As illustrated in FIG. 21, the disk section 20, the mounting section 38, and the fitting target section 39 have a common axis 36, are stacked in this order, and are reduced in diameter in this order. Hereinafter, the side of the disk section 20 is also referred to as “top” with respect to the mounting section 38 and the side of the mounting section 38 is also referred to as “bottom” with respect to the disk section 20 in a direction along the axis 36. However, the terms “top” and “bottom” refer to the relative positional relationship in the dispenser 1 and do not necessarily mean the “top” and the “bottom” in the vertical direction.

As illustrated in FIGS. 21 to 23, the engagement section 35 projects from the opposite side to the nozzle section 23 across the axis 36 of the outer edge of the disk section 20 and extends in the radial direction of the disk section 20. The engagement section 35 has a plate shape and has two side surfaces 351 and 352, a tip edge 353, and a lower end edge 354. The side surfaces 351 and 352 are parallel to each other and expand along a plane including the axis 36. The tip edge 353 is the tip in the radially outside of the disk section 20 of the engagement section 35 and has a linear shape in side view of the engagement section 35. The tip edge 353 is tilted to be gradually close to the axis 36 toward the downward from the upward. The lower end edge 354 is the lower end of the engagement section 35 and has a linear shape extending in the radial direction of the disk section 20 in side view of the engagement section 35. An angle θ1 formed by the tip edge 353 and the lower end edge 354 is an obtuse angle, specifically 110°.

The mounting section 38 has a bottomed cylindrical shape and projects from the lower surface of the disk section 20. In the bottom portion 210 at the lower end of the mounting section 38, the suction port 10 is provided. The flange-shaped projection 211 projects from the upper side of the outer surface of the mounting section 38. The fitting target section 39 has a cylindrical shape and projects from the bottom portion 210 of the mounting section 38. The fitting target section 39 surrounds the circumference of the suction port 10. As illustrated in FIG. 20, the suction pipe 320 can be fitted and connected to the fitting target section 39.

The biasing unit containing hole 27 is formed inside the disk section 20 and the mounting section 38.

The suction valve containing hole 28 is formed inside the mounting section 38 and connected to the other axial end of the biasing unit containing hole 27. The suction valve containing hole 28 has a cylindrical shape with a diameter smaller than that of the biasing unit containing hole 27 and is partitioned by the bottom portion 260 of the mounting section 38. The suction port 10 formed in the bottom portion 260 of the mounting section 38 is connected to the suction valve containing hole 28, thereby making the suction port 10 and the depression 26 communicate with each other. More specifically, a passage connected to the depression 26 from the suction port 10 through the suction valve containing hole 28 and the biasing unit containing hole 27 functions as a suction passage of the liquid material to the pump chamber 11.

As illustrated in FIG. 21, the suction valve 4 is a disc valve formed of a synthetic resin and installed in the suction valve containing hole 28. The suction valve 4 integrally has the valve body 41, a return spring, and a base. The base is a cylindrical portion and arranged facing the inner peripheral surface of the suction valve containing hole 28. The valve body 41 is a disc-shaped portion and arranged inside the base. The return spring is a linear portion extending along the inner periphery of the base and has one end connected to the base and the other end connected to the valve body. Two or more (e.g., three) of the return springs are provided side by side in the circumferential direction of the base. The valve body 41 is installed at the bottom portion 260 of the mounting section 38 to close the suction port 10. When the pressure inside the mounting section 38 becomes lower than the pressure inside the fitting target section 39 and the thrust due to a pressure difference between them exceeds a biasing force of the above-described return springs, the valve body 41 is separated from the bottom portion 260 of the mounting section 38 and the suction port 10 is opened. When the pressure inside the mounting section 38 rises and the thrust due to the above-described pressure difference falls below the biasing force of the above-described return springs, the valve body 41 contacts the bottom portion 260 and the suction port 10 is closed. When the pressure inside the mounting section 38 is equal to or higher than the pressure inside the fitting target section 39, the above-described state in which the suction port 10 is closed is maintained.

In FIG. 21, the return spring 51 is a coil spring and installed in a pressed and contracted state between a retainer 331 provided at the tip of the nozzle section 33 and the valve body 50 and normally biases the valve body 50 toward the valve seat 232.

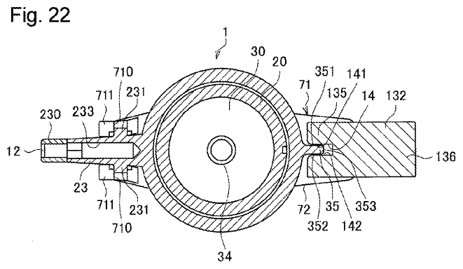

As illustrated in FIGS. 17 and 22, the hole 710 is formed in each hinge portion 711. To the hole 710, the projection 231 of the nozzle section 23 is turnably fitted. The axis of the relative turn between the hole 710 and the projection 231 functions as the fulcrum of the lever 71. The fulcrum of the lever 71 is located on the opposite side to the handle section 13 across the mounting section 38 or the axis 36.

The holding portion 712 faces the handle section 13 of the container 100 in the turning direction of the lever 71. At the initial position of the lever 71, there is a predetermined distance between the holding portion 712 and the handle section 13. The holding portion 712 is positioned at a predetermined height with respect to the second flat surface portion 132 at the upper end of the handle section 13. The above-described predetermined distance is such a distance that a user easily holds and grasps the discharge container 1A by placing the thumb of one hand on the upper surface of the holding portion 712 and hooking any other finger of the hand on the handle section 13, for example. The holding portion 712 functions as the point where force is applied of the lever 71. The holding portion 712 is provided with a shallow and watch glass-shaped dent 713 in the upper surface. The dent 713 facilitates the positioning of a finger in the holding portion 712 and suppresses the finger from slipping against the holding portion 712.

The fixing member 9 is a cylindrical cap with a threaded portion 90 formed on the inner surface and surrounds the mounting section 38. The fixing member 9 is turnable with respect to the mounting section 38. As illustrated in FIG. 21, the fixing member 9 is provided with a locking portion 91 projecting to the inner diameter side and downward at the upper end of the inner periphery. The locking portion 91 is locked with the projection 211 of the mounting section 38, thereby regulating the downward axial movement of the fixing member 9 with respect to the mounting section 38.

In mounting the dispenser 1 to the container 100, a user can position the dispenser 1 in the circumferential direction 200 of the mounting target section 18 of the container 100 by engaging the engagement section 35 of the dispenser 1 with the engagement target section 14 of the container 100. Specifically, the mounting section 38 of the dispenser 1 is mounted to the mounting target section 18 of the container 100. The user inserts the engagement section 35 of the dispenser 1 approaching the container 100 into the engagement target section 14 of the container 100 while inserting the mounting target section 18 of the container 100 into a gap between the outer surface of the mounting section 38 and the inner surface of the fixing member 9. Then, the user can screw the threaded portion 120 of the mounting target section 18 into the threaded portion 90 of the fixing member 9 by turning the fixing member 9 with respect to the mounting target section 18. Thus, the container 100 is fastened and fixed to the dispenser 1, completing the mounting of the dispenser 1 to the container 100. More specifically, the fixing member 9 can fix the dispenser 1 to the container 100 in a state where the engagement section 35 of the dispenser 1 is engaged with the engagement target section 14 of the container 100. As illustrated in FIG. 20, the axis 280 of the container 100 and the axis 36 of the dispenser 1 are aligned with each other in the state where the mounting is completed. In the state where the engagement section 35 is engaged with the engagement target section 14, the discharging opening 12 is positioned on the opposite side to the handle section 13 across the mounting target section 18 of the container 100.

Next, advantages of the above-described configurations are described. The discharge container 1A has the container 100, the dispenser 1, and the fixing member 9. The dispenser 1 has the mounting section 38. The mounting section 38 is mounted to the mounting target section 18 of the container 100. The dispenser 1 can discharge the liquid material from the containing section 17 of the container 100 from the discharging opening 12 in response to an operation of a user. The fixing member 9 is a member different from the dispenser 1 and the container 100 and is provided to be able to fix the dispenser 1 to the container 100. Hence, the position of the dispenser 1 with respect to the container 100, e.g., the position of the dispenser 1 in the circumferential direction 200 (see FIG. 17) of the mounting target section 18 of the container 100, is adjusted, and then the dispenser 1 can be fixed to the container 100 by the fixing member 9 while holding this position. The fixing member 9 may be a combination cap as a fastening member for fastening the dispenser 1 and the container 100 by screwing. A method for fixing the dispenser 1 and the container 100 by the fixing member 9 is not limited to the screwing and may also be crimping, engagement, or the like. The fixing member 9 and the dispenser 1 may be formed into an integrated unit by locking of the locking portion 91 of the fixing member 9 with the projection 211 of the mounting section 38 of the dispenser 1. The fixing member 9 and the container 100 may be formed into an integrated unit.

The dispenser 1 has the engagement section 35. The engagement section 35 is engageable with the engagement target section 14 of the container 100. The engagement section 35 is provided to regulate the turning of the dispenser 1 around the mounting target section 18 of the container 100 by being engaged with the engagement target section 14. More specifically, the engagement section 35 functions as a positioning stopper regulating the relative turning between the dispenser 1 and the container 100 together with the engagement target section 14 and positions the dispenser 1 in a direction of the above-described turning (the circumferential direction 200 of the mounting target section 18) with respect to the container 100.

The fixing member 9 is provided to be able to fix the dispenser 1 to the container 100 in the state where the engagement section 35 is engaged with the engagement target section 14. More specifically, the dispenser 1 can be positioned in the circumferential direction 200 of the mounting target section 18 of the container 100 by engaging the engagement section 35 and the engagement target section 14 with each other before the dispenser 1 is fixed to the container 100 by the fixing member 9. This facilitates the adjustment of the position of the dispenser 1 in the circumferential direction 200 of the mounting target section 18 in mounting the dispenser 1 to the container 100. Further, the dispenser 1 and the container 100 can be fixed to each other in the state where the engagement section 35 and the engagement target section 14 are engaged with each other, facilitating the fixing of the dispenser 1 to the container 100 by the fixing member 9 while holding the position after the above-described adjustment. In other words, the position of the dispenser 1 in the circumferential direction 200 of the mounting target section 18 can be easily set to a predetermined regular position and the dispenser 1 and the container 100 can be fixed to each other. The engagement section 35 may have a plate shape, and the engagement target section 14 may have a slit shape which allows the entering of the engagement section 35. In other words, the engagement target section 14 may have a slit shape, and the engagement section 35 may have a plate shape which allows the entering into the engagement target section 14. The engagement section 35 may have a rod shape or the like without being limited to the plate shape. More specifically, the engagement section 35 may be a projection which allows the entering into the engagement target section 14 which is a depression. The engagement section 35 may also be a depression depressed with respect to the outer surface of the dispenser body 2 without being limited to a projection projecting from the outer surface of the dispenser body 2. The engagement target section 14 may be a hole or the like without being limited to the slit shape. The engagement target section 14 may be a projection which allows the entering into the engagement section which is a depression without being limited to the depression which allows the entering of the engagement section which is the projection. The engagement target section 14 may be provided anywhere in the container 100 without being limited to the handle section 13.

The handle section 13 is a portion which allows a user to hold and has a shape which is easy to hold. Hence, a user easily holds the discharge container 1A. Specifically, the handle section 13 is a finger hook portion and may have an annular shape or a tubular shape which allows a user to hook the user's finger. In this case, the convenience of the user can be improved. The container 100 has the handle section 13. More specifically, the handle section 13 is provided in the container 100. In other words, the handle section 13 is not provided in the dispenser 1. This facilitates the molding of the dispenser 1. In particular, when the dispenser 1 is reduced in size, e.g., when the diameter of the depression 26 is reduced, the absence of the handle section 13 in the dispenser 1 does not complicate a mold and facilitates the molding of the dispenser body 2. The shape of the handle section 13 may have any shape which allows a user to hold without being limited to the annular shape or the tubular shape and may be any projection projecting from the outer surface of the container 100, for example. Further, the handle section 13 may not project from the outer surface of the container 100 and may be a hole penetrating through the container 100, for example.

The engagement section 35 is engaged with the engagement target section 14, thereby positioning the discharging opening 12 of the dispenser 1 in the circumferential direction 200 of the mounting target section 18 of the container 100 with respect to the handle section 13 of the container 100. By adjusting the position of the discharging opening 12 with respect to the handle section 13 as described above, the liquid material can be discharged in an appropriate direction with respect to the holding position in the state where the user holds the handle section 13, and therefore the usability of the discharge container 1A can be improved.

For example, the discharging opening 12 of the dispenser 1 may be provided to be positioned on the opposite side to the handle section 13 of the container 100 across the mounting target section 18 of the container 100 in the state where the engagement section 35 is engaged with the engagement target section 14. In this case, the discharging opening 12 is located on the opposite side to the holding position in the state where a user holds the handle section 13, making it easy for the user to extract the liquid material. The user can discharge the liquid material from the discharging opening 12 by tilting the discharge container 1A such that the discharging opening 12 is relatively moved to the vertical lower side, for example, while holding the handle section 13. The above-described opposite side is not limited to the diametrically opposite side and may be any region where the angle formed by the discharging opening 12 and the handle section 13 with the mounting target section 18 (the axis 280) as the apex is 90° or larger. The discharging opening 12 may be provided to be located at a 90° position with respect to the handle section 13 with the mounting target section 18 as the apex without being limited to the opposite side across the mounting target section 18 in the state where the engagement section 35 is engaged with the engagement target section 14. In this case, the user can easily direct the discharging opening 12 to the user's face while holding the handle section 13. Therefore, when the user uses a lotion as the liquid material and sprays the same, for example, the user easily sprays the lotion to the user's face.

The engagement target section 14 may be provided in the handle section 13 of the container 100. In this case, there is no necessity of providing the engagement target section 14 in the other sites of the container 100, and therefore the degree of freedom of shape of the other sites can be improved. The above-described other sites include the containing section 17, for example. The engagement target section 14 may be provided in the above-described other sites in the container 100. The engagement target section 14 may be provided in the first curved surface portion 135 as a corner portion of the handle section 13, for example. In this case, the engagement target section 14 can extend over a larger angle range. For example, when the engagement target section 14 has the slit shape, the engagement target section 14 can be opened not only in the up and down direction but in the horizontal direction. Hence, the engagement target section 14 can be more easily engaged with the engagement section 35. In the dispenser 1, the engagement section 35 may be provided on the opposite side to the discharging opening 12 across the mounting section 38. In this case, when the engagement target section 14 is provided in the handle section 13, the engagement of the engagement section 35 with the engagement target section 14 facilitates the positioning of the discharging opening 12 on the opposite side to the handle section 13 across the mounting target section 18.

The handle section 13 may project to the same side as the mounting target section 18 from the outer surface of the container 100. In other words, the handle section 13 may project to the side of the dispenser 1 from the outer surface of the container 100. In this case, when the engagement target section 14 is provided in the handle section 13, the engagement target section 14 is brought close to the dispenser 1, facilitating the engagement of the engagement section 35 with the engagement target section 14. In other words, the configuration of the engagement target section 14 or the engagement section 35 can be simplified or reduced in size.

When the dispenser 1 is a pump type, the discharge container 1A can discharge the liquid material due to the pumping action of the dispenser 1 irrespective of the attitude. The dispenser 1 is not limited to the pump type and may be one in which a user holds the handle section 13 and tilts the entire of the discharge container 1A such that the discharging opening 12 is relatively displaced vertically downward, thereby causing the liquid material to discharge from the discharging opening 12, for example.

The dispenser 1 may have the lever 71. It may be acceptable that the lever 71 is provided in the dispenser body 2 and can press the lid section 30 as the movable member by being operated by a user. In this case, the leverage can reduce a force for a liquid material extraction operation by a user, and thus the extraction operation can be facilitated. When the biasing unit 8 is provided which promotes the return of the movable member to the initial position, a larger operation force may be needed corresponding to the biasing force of the biasing unit 8. In contrast, the operation force can be reduced by providing the lever 71. The dispenser 1 may not have the lever 71 or the pressing portion 70.

The point where force is applied (the holding portion 712) of the lever 71 may be provided to be positioned on the side of the handle section 13 with respect to the mounting target section 18 of the container 100 in the state where the engagement section 35 is engaged with the engagement target section 14. In other words, the fulcrums (the hole 710 and the projection 231) of the lever 71 may be provided to be positioned on the opposite side to the handle section 13 across the mounting target section 18 of the container 100. In this case, the container 100 and the dispenser 1 are positioned relative to each other such that the above-described engagement brings the handle section 13 and the point where force is applied of the lever 71 close to each other, making it easy for a user to operate the lever 71 with the same hand grasping the handle section 13.

When the dispenser 1 has the lever 71, there is a risk that, when a user operates the lever 71, a force acts on the dispenser 1, so that the dispenser 1 performs a turning displacement, i.e., a swing motion, with the mounting section 38 as the center in the plane along the movement direction of the lever 71 (e.g., in the paper surface of FIG. 20) with respect to the container 100. In contrast, the engagement section 35 may be provided to regulate the displacement of the dispenser body 2 with respect to the container 100 in a pressing direction A (in other words, downward) of the lever 71 indicated by the arrow in FIG. 20 by being engaged with the engagement target section 14. Specifically, the lower end edge 354 of the engagement section 35 abuts on the inner surface 143 of the engagement target section 14 facing the same in the pressing direction A of the lever 71. In this case, even when the dispenser body 2 is to be displaced with respect to the container 100 in the pressing direction A of the lever 71 when a user operates the lever 71, this displacement is regulated by the above-described abutment. Hence, the above-described swing motion is suppressed. This suppresses the deviation of the position of the discharging opening 12 from a predetermined regular position in the discharge container 1A in the use of the discharge container 1A, making it easy to discharge the liquid material to a targeted position. Further, the swing motion of the dispenser 1 is suppressed in the pressing by the lever 71, and therefore a user can easily operate the lever 71 and can firmly press the lever 71, and therefore a desired discharge amount can be stably obtained and the usability of the discharge container 1A can be improved.

The engagement section 35 may be provided on the opposite side to the fulcrums (the hole 710 and the projection 231) of the lever 71 across the mounting section 38. In this case, the engagement section 35 is positioned on the same side as the point where force is applied (the holding portion 712) of the lever 71 with respect to the mounting section 38. More specifically, it is convenient that the mounting section 38 is used as a passage of the liquid material from the containing section 17 of the container 100 to the dispenser 1. In this case, the pump chamber 11 is preferably provided in the vicinity of the mounting section 38. Hence, the point of action (the pressing portion 70) of the lever 71 is positioned in the vicinity of the mounting section 38, and therefore the point where force is applied of the lever 71 is likely to be positioned on the opposite side to the fulcrums of the lever 71 across the mounting section 38. Thus, the engagement section 35 is positioned on the same side as the point where force is applied of the lever 71 with respect to the mounting section 38. Thus, the engagement section 35 is likely to be displaced in the same direction as the pressing direction A of the lever 71. The pressing direction A of the lever 71 is usually a direction toward the container 100, and therefore the engagement section 35 is likely to be engaged with the engagement target section 14 of the container 100. Specifically, the lower end edge 354 of the engagement section 35 is pressed against the inner surface 143 of the engagement target section 14 facing the same in the pressing direction A of the lever 71. Hence, the displacement of the lever 71 in the pressing direction A with respect to the container 100 of the dispenser body 2, i.e., the above-described swing motion, can be effectively regulated.

The displacement of the engagement section 35 in the same direction as the pressing direction A of the lever 71 facilitates the simplification of the shape of the engagement target section 14 or a method for mounting the dispenser 1 to the container 100. For example, it is sufficient to form the engagement target section 14 into a slit shape. In that case, the inner surface 143 of the engagement target section 14 functions as a stopper, and thus the displacement of the dispenser body 2 with respect to the container 100 in the pressing direction A of the lever 71 can be regulated. At this time, an upper portion of the inner surface 143 of the engagement target section 14, i.e., the upper side of the engagement target section 14, may remain open, and thus the shape of the engagement target section 14 can be simplified. For the above-described engagement, it is sufficient to insert the engagement section 35 from the above-described opening of the engagement target section 14 along the axis 280 of the container 100. This eliminates the necessity of tilting the dispenser 1 with respect to the container 100 in mounting the dispenser 1 to the container 100. Hence, a mounting method can be simplified. The engagement section 35 may be provided on the side of the fulcrums of the lever 71 across the mounting section 38. In this case, the engagement section 35 is likely to be displaced in a direction opposite to the pressing direction A of the lever 71. The shape of the engagement target section 14, the method for mounting the dispenser 1 to the container 100, or the like may be adjusted such that the engagement section 35 is engaged with the engagement target section 14 of the container 100 in this opposite direction.

It may be acceptable that the dispenser body 2 has the depression 26 and the movable member forming the pump chamber 11 is the elastically deformable lid section 30 covering the depression 26 and forming the pump chamber 11 together with the depression 26. For example, the lid section 30 may have an elastically deformable membranous shape. In this case, the diameter of the pump chamber 11 is relatively made large, and thus an increase in the discharge amount in a single extraction operation can be achieved while suppressing the stroke amount of the movable member. Meanwhile, there is a risk that an increase in the diameter of the pump chamber 11 requires a larger operation force. In contrast, when the lever 71 is provided, the operation force can be reduced and the liquid material extraction operation can be facilitated. The lever 71 is provided with the pressing portion 70 for pressing the lid section 30, and thus the lid section 30 can be easily and greatly elastically deformed and an increase in the discharge amount can be achieved. When the movable member is the elastically deformable lid section 30, there is a risk that the increase in the diameter of the pump chamber 11 increases the moment of a force acting on the dispenser 1 in the operation of the lever 71. Hence, it can be said that the above-described swing motion is likely to occur. In contrast, the engagement section 35 and the engagement target section 14 are provided to regulate the displacement of the dispenser body 2 in the pressing direction A of the lever 71 by the engagement between both the engagement section 35 and the engagement target section 14, and thus the above-described swing motion can be effectively regulated. The lid section 30 may have a dome shape bulging out to the opposite side to the side of the depression 26. More specifically, the pump chamber 11 of the dispenser 1 may be a so-called dome-shaped pump. Thus, the amount of the liquid material which can be extracted by a single operation can be more effectively increased while suppressing the enlargement of the dispenser 1. The form of the pump chamber 11 is not limited to the dome-shaped pump, and the elastically deformable lid section 30 may not bulge out to the opposite side to the side of the depression 26. The movable member is not limited to the elastically deformable lid section 30 and may be a piston or the like moving in a cylinder.

It may be acceptable that the engagement section 35 has a plate shape expanding along the pressing direction A of the lever 71 and the engagement target section 14 has a slit shape which allows the entering of the engagement section 35 along the pressing direction A of the lever 71. In this case, the lower end edge 354 of the engagement section 35 having the plate shape can abut on the inner surface 143 of the engagement target section 14 having the slit shape in the pressing direction A of the lever 71. This can regulate the displacement of the dispenser body 2 in the pressing direction A of the lever 71 with respect to the container 100. Herein, a force acts on the engagement section 35 not in the thickness direction but in the longitudinal direction or in the width direction of the plate by the above-described abutment, and therefore the engagement section 35 can efficiently receive a force due to the pressing by the lever 71, and the durability of the engagement section 35 can be improved. The side surfaces 351 and 352 of the engagement section 35 having the plate shape can abut on the inner surfaces 141 and 142, respectively, of the engagement target section 14 having the slit shape in the circumferential direction 200 of the mounting target section 18 which is the turning direction of the dispenser 1 with respect to the mounting target section 18 of the container 100. The side surfaces 351 and 352 expand along the pressing direction A of the lever 71. Hence, even when the position of the dispenser 1 with respect to the container 100 is slightly deviated, e.g., turning displacement or the like of the dispenser 1 with the mounting section 38 as the center, in the plane along the movement direction of the lever 71 (e.g., in the paper surface of FIG. 20) in mounting the dispenser 1 to the container 100 while positioning the same in the circumferential direction 200, the engagement section 35 is likely to abut on the inner surfaces 141 and 142 of the engagement target section 14. Hence, the engagement between the engagement section 35 and the engagement target section 14 is easily maintained during a work of mounting the dispenser 1 to the container 100 while positioning the same in the above-described circumferential direction 200, and therefore the above-described work can be facilitated.

The slit-shaped engagement target section 14 is provided in the first curved surface portion 135 as the corner portion of the handle section 13. Hence, the angle θ1 formed by the tip edge 353 and the lower end edge 354 of the plate-shaped engagement section 35 may be an obtuse angle. The lower end edge 354 is the end edge positioned on the lower side, i.e., the side of the mounting section 38, of the engagement section 35. The lower end edge 354 and the tip edge 353 are two end portions facing the first curved surface portion 135 of the handle section 13 when the engagement section 35 enters the engagement target section 14 among a plurality of end edges of the engagement section 35 having the plate shape. In the case where the above-described angle θ1 is an obtuse angle, the corner portion interposed between the tip edge 353 and the lower end edge 354 is less likely to interfere with the first curved surface portion 135 provided with the engagement target section 14 and is likely to enter the engagement target section 14 when the engagement section 35 enters the engagement target section 14. This can facilitate the work of engaging the engagement section 35 with the engagement target section 14. The end edge of the engagement section 35 facing the first curved surface portion 135 may not have a linear shape and may have a curved shape.

### Sixth Embodiment

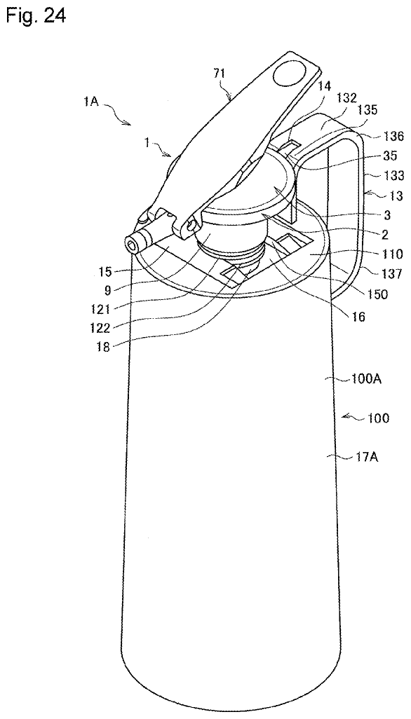

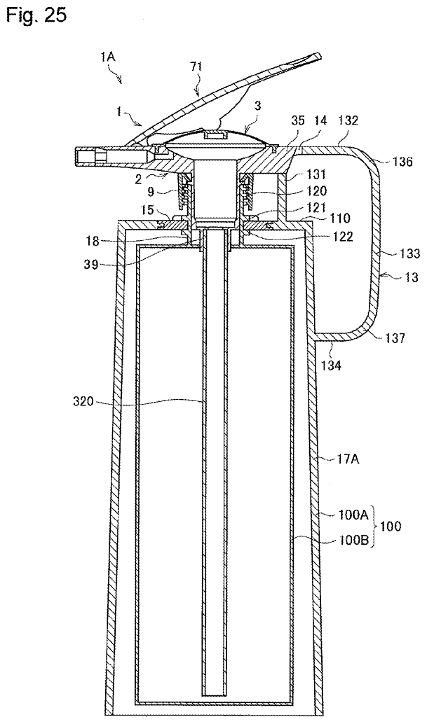

FIGS. 24 and 25 illustrate the configuration of the discharge container 1A of this embodiment. FIG. 25 is a cross-sectional view similar to FIG. 20. This embodiment illustrates an example in which the container 100 is a so-called delamination container. The same sings as those of the fifth embodiment are attached to the configurations common to those of the fifth embodiment and descriptions thereof are omitted.

The container 100 has a container holder 100A and an inner bag 100B. The container holder 100A has an outer-shell containing section 17A, the handle section 13, the engagement target section 14, and a slide lid section 15. The outer-shell containing section 17A has a bottle shape as with the containing section 17 of the first embodiment and has the lower end opened to the outside. The handle section 13 is provided integrally with the outer-shell containing section 17A. The slide lid section 15 is installed on the upper surface 110 of the outer-shell containing section 17A to be slidable with respect to the outer-shell containing section 17A. By the sliding of the slide lid section 15 with respect to the outer-shell containing section 17A, the upper surface 110 of the outer-shell containing section 17A is opened/closed. As illustrated in FIG. 24, the slide lid section 15 is provided with a depression 150 opened to the outer edge of the slide lid section 15.

The inner bag 100B is a flexible bag and contains the liquid material. The inner bag 100B is contractible with a reduction in the liquid material. The inner bag 100B is provided with the mounting target section 18. On the outer periphery of the mounting target section 18, a first locking portion 121 and a second locking portion 122 having a flange shape are provided below the threaded portion 120.

The inner bag 100B is inserted into the outer-shell containing section 17A from the lower end of the outer-shell containing section 17A to be contained in the outer-shell containing section 17A. In a state where the slide lid section 15 slides in the outer radial direction of the outer-shell containing section 17A, so that the upper surface 110 of the outer-shell containing section 17A is opened, the mounting target section 18 of the inner bag 100B projects from the upper surface 110 of the outer-shell containing section 17A to the outside of the container holder 100A. When the slide lid section 15 is caused to slide to close the upper surface 110 of the outer-shell containing section 17A, portions facing each other across the depression 150 of the slide lid section 15 are fitted between the first locking portion 121 and the second locking portion 122 of the mounting target section 18. Thus, the inner bag 100B is fixed to the outer-shell containing section 17A and installed in the container holder 100A. The mounting target section 18 penetrates through the depression 150 of the slide lid section 15 and projects to the outside of the container holder 100A. As illustrated in FIG. 24, a gap 16 remaining in the depression 150 allows a space between the inner bag 100B and the container holder 100A to communicate with the outside of the container holder 100A, thereby functioning as a breathing hole facilitating the contraction of the inner bag 100B with a reduction in the liquid material. When the slide lid section 15 is caused to slide in the opposite direction to open the upper surface 110 of the outer-shell containing section 17A, the slide lid section 15 is released from between the first locking portion 121 and the second locking portion 122 of the mounting target section 18. Thus, the inner bag 100B can be removed from the outer-shell containing section 17A.

A set of the dispenser 1 and the container holder 100A functions as a container holder with dispenser. The engagement section 35 of the dispenser 1 is provided to regulate the turning of the dispenser 1 around the mounting target section 18 of the inner bag 100B installed in the container holder 100A by being engaged with the engagement target section 14 of the container holder 100A. This facilitates the adjustment of the position of the dispenser 1 in the circumferential direction of the mounting target section 18 in mounting the dispenser 1 to the container 100 as with the first embodiment. The fixing member 9 is provided to be able to fix the dispenser 1 to the mounting target section 18 of the inner bag 100B installed in the container holder 100A in the state where the engagement section 35 is engaged with the engagement target section 14. This facilitates the fixation of the dispenser 1 to the container 100 by the fixing member 9 while holding the position after the above-described adjustment.

When the container 100 is provided with the inner bag 100B as described above, there is no need to supply air to the inner bag 100B when the liquid material is supplied from the container 100 to the dispenser 1, and thus the sealability of the liquid material can be improved and the liquid material can be kept clean. Further, the liquid material can be resupplied by replacing the inner bag 100B without discarding the container holder 100A, facilitating the recycle of the container 100. The suction pipe 320 may not be connected to the fitting target section 39 of the dispenser 1.

When the container 100 is provided with the inner bag 100B removable from the container holder 100A and interchangeable and the inner bag 100B is provided with the mounting target section 18, the inner bag 100B is removed from the dispenser 1 and the mounting between the dispenser 1 and the container 100 is released every time when the inner bag 100B is changed. In other words, the dispenser 1 and the container 100 need to be remounted every time when the inner bag 100B is changed. Hence, the above-described advantage that the dispenser 1 and the container 100 are positioned by the engagement between the engagement section 35 and the engagement target section 14 in the above-described mounting, and the dispenser 1 can be fixed to the container 100 by the fixing member 9 while holding this position can be obtained at each change described above, and therefore the convenience of the discharge container 1A can be improved. The inner bag 100B may be removably installed in the container holder 100A, and an installation method therefor is not limited to the method using the slide lid section 15.

As described above, suitable embodiments of the present invention are described in detail with reference to the accompanying drawings but the technical scope of the present invention is not limited to such examples. It is clear that a person having ordinary knowledge in the technical field of the present invention can conceive various changes or modifications within the scope of the technical idea described in Claims, and it is naturally understood that these changes or modifications belong to the technical scope of the present invention.

With respect to the embodiments described above, the present invention further discloses the following dispensers or discharge containers.

Further, with respect to the embodiments described above, the present invention further discloses the following discharge containers, dispensers, containers, container holders with dispenser, dispensers, or container holders.

<1>

A dispenser capable of discharging a liquid material from a discharging opening including: a dispenser body having a depression; an elastically deformable lid section covering an opening of the depression and forming a pump chamber together with the depression; a pressing portion arranged facing the lid section on the outside of the pump chamber, capable of pressing the lid section to the side where the volume of the pump chamber decreases, and provided to be able to enter the inside of the depression while pressing the lid section for elastic deformation; an outlet causing the liquid material inside the pump chamber to flow out toward the discharging opening when the pressing portion presses the lid section; and an inlet provided separately from the outlet and causing the liquid material to flow into the pump chamber when the pressing to the lid section by the pressing portion is released.

<2>

The dispenser as set forth in clause <1>, in which the dispenser body further has a suction port communicating with the inlet, and the liquid material is sucked into the pump chamber from the suction port through the inlet.

<3>

The dispenser as set forth in clause <2>, in which the pump chamber is provided on a passage connecting the suction port and the discharging opening to each other.

<4>

The dispenser as set forth in clause <2> or <3>, further including a suction valve blocking the communication between the suction port and the inlet when the pressing portion presses the lid section.

<5>

The dispenser as set forth in any one of clauses <1> to <4>, further including a discharge valve blocking the communication between the discharging opening and the outlet when the pressing to the lid section by the pressing portion is released.

<6>

The dispenser as set forth in any one of clauses <1> to <5>, in which the outlet and the inlet are provided in the pump chamber.

<7>

The dispenser as set forth in any one of clauses <1> to <6>, in which the outlet and the inlet are opened to the bottom surface of the depression.

<8>

The dispenser as set forth in any one of clauses <1> to <7>, in which the opening area of the outlet is smaller than the opening area of the inlet.

<9>

The dispenser as set forth in any one of clauses <1> to <8>, in which the lid section bulges out to the opposite side to the side of the depression.

<10>

The dispenser as set forth in any one of clauses <1> to <9>, in which the pressing portion has a shape corresponding to the depression.

<11>

The dispenser as set forth in any one of clauses <1> to <10>, in which the lid section pressed by the pressing portion is elastically deformed into a shape following the depression in a state where the pressing portion enters the inside of the depression.

<12>

The dispenser as set forth in any one of clauses <1> to <11>, in which the pressing portion is provided to press the lid section for elastic deformation, thereby allowing ⅓ or more of the lid section to enter the inside of the depression.

<13>

The dispenser as set forth in clause <12>, in which the pressing portion is provided to press the lid section for elastic deformation, thereby allowing a half or more of the lid section to enter the inside of the depression.

<14>

The dispenser as set forth in any one of clauses <1> to <13>, in which the depression becomes gradually deeper toward the center side from the outer peripheral edge of the depression.

<15>

The dispenser as set forth in clause <14>, in which the depression is depressed in the shape of a watch glass.

<16>

The dispenser as set forth in any one of clauses <1> to <15>, in which the bottom surface of the depression has a circular shape in plan view.

<17>

The dispenser as set forth in any one of clauses <1> to <16>, in which at least a part of the tip surface of the pressing portion has a shape along the bottom surface of the depression facing the same.

<18>

The dispenser as set forth in any one of clauses <1> to <17>, in which the curvature of at least a part of the tip surface of the pressing portion is equal to the curvature of the bottom surface of the depression facing the same.

<19>

The dispenser as set forth in any one of clauses <1> to <18>, in which the pressing portion includes a projection projecting from the tip surface of the pressing portion.

<20>

The dispenser as set forth in any one of clauses <1> to <19>, further including a lever rotatable with respect to the dispenser body, in which the pressing portion has a projection shape projecting from the lever to the side of the lid section.

<21>

The dispenser as set forth in clause <20>, in which the dimension in the plate width direction perpendicular to the longitudinal direction of the lever of a region including the tips of the pressing portion in plan view of the lever is larger than the radius of the lid section.

<22>

The dispenser as set forth in clause <20> or <21>, in which the outer edge in the plate width direction perpendicular to the longitudinal direction of the lever of the region including the tips of the pressing portion in plan view of the lever is located on the side of the outer peripheral edge of the lid section relative to the midpoint between the outer peripheral edge and the center of the lid section.

<23>

The dispenser as set forth in any one of clauses <20> to <22>, in which the shape of the tip surface of the pressing portion is provided such that the elastic deformation amount of the lid section is smaller on the side far from the fulcrums of the lever than on the side close to the fulcrums of the lever.

<24>

The dispenser as set forth in any one of clauses <20> to <23>, in which a region on the side of the fulcrums of the lever of the tip surface of the pressing portion has a curvature equal to the curvature of the bottom surface of the depression facing the same, and a region on the opposite side to the side of the fulcrums of the lever has a curvature larger than the curvature of the bottom surface of the depression facing the same.

<25>

The dispenser as set forth in any one of clauses <20> to <24>, in which the shape of the tip surface of the pressing portion is provided such that at least a part of a region on the opposite side to the side of the fulcrums of the lever of the tip surface of the pressing portion is separated from the upper surface of the lid section.

<26>

The dispenser as set forth in any one of clauses <20> to <25>, in which the fulcrums of the lever are positioned at a height between the opening and the deepest part of the depression in side view of the depression.

<27>

The dispenser as set forth in any one of clauses <20> to <26>, in which the lever has a hinge portion and a holding portion, the hinge portion is located at one longitudinal end of the lever, and the holding portion is located at the other longitudinal end of the lever.

<28>

The dispenser as set forth in any one of clauses <1> to <27>, in which the pressing portion has a shape in which one projection is reduced in thickness in the shape of a plurality of stripes and includes a plurality of plate portions.

<29>

The dispenser as set forth in clause <28>, in which the tip surface of the pressing portion is an envelope surface passing through the tips of the plurality of plate portions.

<A1>

A dispenser capable of discharging a liquid material from a discharging opening including: a dispenser body; an elastically deformable lid section attached to the dispenser body and forming a pump chamber together with the dispenser body; a biasing unit arranged inside the dispenser body and capable of pressing the inner surface of the lid section; and a lever provided rotatably with respect to the dispenser body and having a pressing portion capable of pressing the outer surface of the lid section, in which the pressing portion and the biasing unit are provided such that, when the biasing unit starts to press the inner surface of the lid section in response to the elastic deformation of the lid section by the pressing by the pressing portion, a pressed site of the outer surface of the lid section by the pressing portion and a pressed site of the inner surface of the lid section by the biasing unit are superimposed on each other, and the liquid material in the pump chamber is discharged from the discharging opening by the pressing to the lid section by the pressing portion.

<A2>

The dispenser as set forth in any one of clauses <1> to <29> and <A1>, in which the pressed site of the inner surface of the lid section by the biasing unit is located on the side of a center portion relative to the outer peripheral edge in the lid section.

<A3>

The dispenser as set forth in any one of clauses <1> to <29> and <A1> and <A2>, in which the lid section has a locking portion projecting from the inner surface of the lid section, and a part of the biasing unit is locked with the locking portion.

<A4>

The dispenser as set forth in any one of clauses <1> to <29> and <A1> to <A3>, in which the dispenser body has the depression, the lid section forms the pump chamber together with the depression, and the dispenser body further has a biasing unit containing hole opened to a bottom portion of the depression and capable of containing a part of the biasing unit.

<A5>

The dispenser as set forth in any one of clauses <1> to <29> and <A1> to <A4>, in which the dispenser body has the depression, the lid section forms the pump chamber together with the depression, the dispenser body further has a suction port communicating with the depression, and the liquid material is sucked into the pump chamber from the suction port.

<A6>

The dispenser as set forth in any one of clauses of <1> to <29> and <A1> to <A5>, in which the dispenser body has the depression, the lid section is provided to cover the opening of the depression and has a bulging portion bulging out to the opposite side to the side of the depression, and the pressing portion and the biasing unit are provided such that, when the biasing unit starts to press the inner surface of the bulging portion in response to the elastic deformation of the bulging portion by the pressing by the pressing portion, a pressed site of the outer surface of the bulging portion by the pressing portion and a pressed site of the inner surface of the bulging portion by the biasing unit are superimposed on each other.

<A7>

The dispenser as set forth in any one of clauses <1> to <29> and <A1> to <A6>, in which the tips of the pressing portion facing the lid section have a projecting surface projecting toward the lid section.

<A8>

The dispenser as set forth in clause <A7>, in which the pressing portion has a projection projecting from the projecting surface.

<A9>

The dispenser as set forth in any one of clauses <1> to <29> and <A1> to <A8>, in which the biasing unit has a coil spring capable of generating a biasing force for pressing the inner surface of the lid section.

<A10>

The dispenser as set forth in clause <A9>, in which the pressed site of the outer surface of the lid section by the pressing portion and an axial end portion of the coil spring facing the inner surface of the lid section are provided to be superimposed on each other when the biasing unit starts to press the inner surface of the lid section in response to the elastic deformation of the lid section by the pressing by the pressing portion.

<A11>

The dispenser as set forth in clause <A9> or <A10>, in which the biasing unit has a first support and a second support supporting the coil spring, and the first support and the second support are slidable with respect to each other along the axial direction of the coil spring.

<A12>

The dispenser as set forth in clause <A11>, in which the pressed site of the outer surface of the lid section by the pressing portion and an axial end portion of the support facing the inner surface of the lid section of the first support and the second support are provided to be superimposed on each other when the biasing unit starts to press the inner surface of the lid section in response to the elastic deformation of the lid section by the pressing by the pressing portion.

<A13>

The dispenser as set forth in clause <A12>, in which the first support and the second support are provided to be engageable with each other in a direction where the biasing unit stretches.

<A14>

The dispenser as set forth in any one of clauses <1> to <29> and <A1> to <A13>, in which the lever has a hinge portion and a holding portion, the hinge portion is located at one longitudinal end of the lever, and the holding portion is located at the other longitudinal end of the lever.

<A15>

The dispenser as set forth in any one of clauses <1> to <29> and <A1> to <A14>, in which the dispenser body has the depression, the lid section is provided to cover the opening of the depression, and the fulcrums of the lever are positioned at a height between the opening and the deepest part of the depression in side view of the depression.

<A16>

A discharge container including the dispenser as set forth in any one of clauses <1> to <29> and <A1> to <A15> and a container containing the liquid material.

<B1>

A discharge container including: a container having a containing section containing a liquid material, a handle section which can be held by a user, a mounting target section, and an engagement target section; a dispenser having a mounting section mounted to the mounting target section of the container and an engagement section engaged with the engagement target section of the container and discharging the liquid material from the containing section of the container from a discharging opening in response to an operation of a user; and a fixing member fixing the dispenser to the container, in which the engagement section is provided to regulate the turning of the dispenser around the mounting target section of the container by being engaged with the engagement target section, and the fixing member is provided to be able to fix the dispenser to the container in a state where the engagement section is engaged with the engagement target section.

<B2>

The discharge container as set forth in clause <B1>, in which the discharging opening of the dispenser is provided to be positioned on the opposite side to the handle section of the container across the mounting target section of the container in the state where the engagement section is engaged with the engagement target section.

<B3>

The discharge container as set forth in clause <B1> or <B2>, in which the engagement section is provided on the opposite side to the discharging opening across the mounting section.

<B4>

The discharge container as set forth in any one of clauses <B1> to <B3>, in which the engagement section is a projection and the engagement target section is a depression which allows the entering of the engagement section.

<B5>

The discharge container as set forth in any one of clauses <B1> to <B4>, in which the engagement section has a plate shape and the engagement target section has a slit shape which allows the entering of the engagement section.

<B6>

The discharge container as set forth in any one of clauses <B1> to <B5>, in which the handle section projects from the outer surface of the container to the same side as the mounting target section.

<B7>

The discharge container as set forth in any one of clauses <B1> to <B6>, in which the engagement target section is provided in the handle section.

<B8>

The discharge container as set forth in any one of clauses <B1> to <B7>, in which the engagement target section is provided in a corner portion of the handle section.

<B9>

The discharge container as set forth in any one of clauses <B1> to <B8>, in which the angle formed by two end edges, among two or more of the end edges of the engagement section having the plate shape, facing the corner portion of the handle section when the engagement section enters the engagement target section having the slit shape is an obtuse angle.

<B10>

The discharge container as set forth in any one of clauses <B1> to <B9>, in which the dispenser further has a dispenser body; a movable member forming a pump chamber together with the dispenser body; and a lever provided in the dispenser body and capable of pressing the movable member by being operated by a user, and the movable member is provided such that the liquid material is sucked into the pump chamber or the liquid material is discharged from the pump chamber by displacement of the movable member.

<B11>

The discharge container as set forth in clause <B10>, in which the dispenser body has a depression and the movable member is an elastically deformable lid section covering the depression and forming the pump chamber together with the depression.

<B12>

The discharge container as set forth in clause <B10> or <B11>, in which the engagement section is provided to regulate the displacement of the dispenser body with respect to the container in the pressing direction of the lever by being engaged with the engagement target section.

<B13>

The discharge container as set forth in any one of clauses <B10> to <B12>, in which the engagement section is provided on the opposite side to the fulcrums of the lever across the mounting section.

<B14>

The discharge container as set forth in any one of clauses <B10> to <B13>, in which a point where force is applied of the lever is provided to be positioned on the side of the handle section with respect to the mounting target section of the container in the state where the engagement section is engaged with the engagement target section.

<B15>

The discharge container as set forth in any one of clauses <B10> to <B14>, in which the engagement section has a plate shape expanding along the pressing direction of the lever, and the engagement target section has a slit shape which allows the entering of the engagement section along the pressing direction of the lever.

<B16>

A dispenser having; a mounting section mountable to a mounting target section of a container containing a liquid material and having a handle section which can be held by a user; and an engagement section engageable with an engagement target section of the container, the mounting section being provided with a fixing member, and the dispenser discharging the liquid material from the container from a discharging opening in response to an operation of a user, in which the engagement section is provided to regulate the turning of the dispenser around the mounting target section of the container by being engaged with the engagement target section, and the fixing member is provided to be able to fix the dispenser to the container in a state where the engagement section is engaged with the engagement target section.

<B17>

The dispenser as set forth in clause <B16>, in which the engagement section is provided on the opposite side to the discharging opening across the mounting section.

<B18>

The dispenser as set forth in clause <B16> or <B17>, in which the engagement section is a projection capable of entering the engagement target section which is a depression.

<B19>

The dispenser as set forth in any one of clauses <B16> to <B18>, in which the engagement section has a plate shape which allows the entering into the engagement target section having a slit shape.

<B20>

The dispenser as set forth in any one of clauses <B16> to <B19>, in which the angle formed by two end edges, among two or more of the end edges of the engagement section having the plate shape, facing a corner portion of the handle section when the engagement section enters the engagement target section having the slit shape is an obtuse angle.

<B21>

The dispenser as set forth in any one of clauses <B16> to <B20> further having: a dispenser body; a movable member forming a pump chamber together with the dispenser body; and a lever provided in the dispenser body and capable of pressing the movable member by being operated by a user, in which the movable member is provided such that the liquid material is sucked into the pump chamber or the liquid material is discharged from the pump chamber by displacement of the movable member.

<B22>

The dispenser as set forth in clause <B21>, in which the dispenser body has a depression and the movable member is an elastically deformable lid section covering the depression and forming the pump chamber together with the depression.

<B23>

The dispenser as set forth in clause <B21> or <B22>, in which the engagement section is provided to regulate the displacement of the dispenser body with respect to the container in the pressing direction of the lever by being engaged with the engagement target section.

<B24>

The dispenser as set forth in any one of clauses <B21> to <B23>, in which the engagement section is provided on the opposite side to the fulcrums of the lever across the mounting section.

<B25>

The dispenser as set forth in any one of clauses <B21> to <B24>, in which the engagement section has a plate shape expanding along the pressing direction of the lever.

<B26>

A container having: a containing section containing a liquid material; a handle section which can be held by a user; a mounting target section to which a mounting section of a dispenser is mountable, the dispenser discharging the liquid material from the containing section from a discharging opening in response to an operation of a user; and an engagement target section with which an engagement section of the dispenser is engageable, in which a fixing member is provided to be able to fix the dispenser to the container in a state where the engagement section is engaged with the engagement target section, and the engagement target section is provided to regulate the turning of the dispenser around the mounting target section by the engagement of the engagement section.

<B27>

The container as set forth in clause <B26>, in which the engagement target section is provided in the handle section.

<B28>

The container as set forth in clause <B26> or <B27>, in which the handle section projects from the outer surface of the container to the same side as the mounting target section.

<B29>

The container as set forth in any one of clauses <B26> to <B28>, in which the engagement target section is provided in a corner portion of the handle section.

<B30>

The container as set forth in any one of clauses <B26> to <B29>, in which the engagement target section is a depression which allows the entering of the engagement section which is a projection.

<B31>

The container as set forth in any one of clauses <B26> to <B30>, in which the engagement target section has a slit shape which allows the entering of the engagement section having a plate shape.

<B32>

A container holder with dispenser including: a container holder in which an inner bag containing a liquid material and provided with a mounting target section is removably installed and which has a handle section which can be held by a user and an engagement target section; a dispenser having a mounting section mounted to the mounting target section of the inner bag installed in the container holder and an engagement section engaged with the engagement target section of the container holder and discharging the liquid material from the inner bag installed in the container holder from a discharging opening in response to an operation of a user; and a fixing member fixing the dispenser to the mounting target section of the inner bag installed in the container holder, in which the engagement section is provided to regulate the turning of the dispenser around the mounting target section of the inner bag installed in the container holder by being engaged with the engagement target section, and the fixing member is provided to be able to fix the dispenser to the mounting target section of the inner bag installed in the container holder in a state where the engagement section is engaged with the engagement target section.

<B33>

The container holder with dispenser as set forth in clause <B32>, in which the discharging opening of the dispenser is provided to be positioned on the opposite side to the handle section of the container holder across the mounting target section of the inner bag installed in the container holder in the state where the engagement section is engaged with the engagement target section.

<B34>

The container holder with dispenser as set forth in clause <B32> or <B33>, in which the engagement section is provided on the opposite side to the discharging opening across the mounting section.

<B35>

The container holder with dispenser as set forth in any one of clauses <B32> to <B34>, in which the engagement section is a projection and the engagement target section is a depression which allows the entering of the engagement section.

<B36>

The container holder with dispenser as set forth in any one of clauses <B32> to <B35>, in which the engagement section has a plate shape and the engagement target section has a slit shape which allows the entering of the engagement section.

<B37>

The container holder with dispenser as set forth in any one of clauses <B32> to <B36>, in which the handle section projects from the outer surface of the container holder to the same side as the mounting target section.

<B38>

The container holder with dispenser as set forth in any one of clauses <B32> to <B37>, in which the engagement target section is provided in the handle section.

<B39>

The container holder with dispenser as set forth in any one of clauses <B32> to <B38>, in which the engagement target section is provided in a corner portion of the handle section.

<B40>

The container holder with dispenser as set forth in any one of clauses <B32> to <B39>, in which the angle formed by two end edges, among two or more of the end edges of the engagement section having the plate shape, facing the corner portion of the handle section when the engagement section enters the engagement target section having the slit shape is an obtuse angle.

<B41>

The container holder with dispenser as set forth in any one of clauses <B32> to <B40>, in which the dispenser further has: a dispenser body; a movable member forming a pump chamber together with the dispenser body; and a lever provided in the dispenser body and capable of pressing the movable member by being operated by a user, in which the movable member is provided such that the liquid material is sucked into the pump chamber or the liquid material is discharged from the pump chamber by displacement of the movable member.

<B42>

The container holder with dispenser as set forth in clause <B41>, in which the dispenser body has a depression and the movable member is an elastically deformable lid section covering the depression and forming the pump chamber together with the depression.

<B43>

The container holder with dispenser as set forth in clause <B41> or <B42>, in which the engagement section is provided to regulate the displacement of the dispenser body with respect to the container holder in the pressing direction of the lever by being engaged with the engagement target section.

<B44>

The container holder with dispenser as set forth in any one of clauses <B41> to <B43>, in which the engagement section is provided on the opposite side to the fulcrums of the lever across the mounting section.

<B45>

The container holder with dispenser as set forth in any one of clauses <B41> to <B44>, in which a point where force is applied of the lever is provided to be positioned on the side of the handle section with respect to the mounting target section of the container holder in a state where the engagement section is engaged with the engagement target section.

<B46>

The container holder with dispenser as set forth in any one of clauses <B41> to <B45>, in which the engagement section has a plate shape expanding along the pressing direction of the lever, and the engagement target section has a slit shape which allows the entering of the engagement section along the pressing direction of the lever.

<B47>

A dispenser having: a mounting section mountable to a mounting target section provided in an inner bag containing a liquid material and removably installed in a container holder having a handle section which can be held by a user; and an engagement section engageable with an engagement target section of the container holder, the mounting section being provided with a fixing member, and the dispenser discharging the liquid material from the inner bag installed in the container holder from a discharging opening in response to an operation of a user, in which the engagement section is provided to regulate the turning of the dispenser around the mounting target section of the inner bag installed in the container holder by being engaged with the engagement target section, and the fixing member is provided to be able to fix the dispenser to the mounting target section of the inner bag installed in the container holder in a state where the engagement section is engaged with the engagement target section.

<B48>

The dispenser as set forth in clause <B47>, in which the engagement section is provided on the opposite side to the discharging opening across the mounting section.

<B49>

The dispenser as set forth in clause <B47> or <B48>, in which the engagement section is a projection capable of entering the engagement target section which is a depression.

<B50>

The dispenser as set forth in any one of clauses <B47> to <B49>, in which the engagement section has a plate shape which allows the entering into the engagement target section having a slit shape.

<B51>

The dispenser as set forth in any one of clauses <B47> to <B50>, in which the angle formed by two end edges, among two or more of the end edges of the engagement section having the plate shape, facing a corner portion of the handle section when the engagement section enters the engagement target section having the slit shape is an obtuse angle.

<B52>

The dispenser as set forth in any one of clauses <B47> to <B51> further having: a dispenser body; a movable member forming a pump chamber together with the dispenser body; and a lever provided in the dispenser body and capable of pressing the movable member by being operated by a user, in which the movable member is provided such that the liquid material is sucked into the pump chamber or the liquid material is discharged from the pump chamber by displacement of the movable member.

<B53>

The dispenser as set forth in clause <B52>, in which the dispenser body has a depression, and the movable member is an elastically deformable lid section covering the depression and forming the pump chamber together with the depression.

<B54>

The dispenser as set forth in clause <B52> or <B53>, in which the engagement section is provided to regulate the displacement of the dispenser body with respect to the container holder in the pressing direction of the lever by being engaged with the engagement target section.

<B55>

The dispenser as set forth in any one of clauses <B52> to <B54>, in which the engagement section is provided on the opposite side to the fulcrums of the lever across the mounting section.

<B56>

The dispenser as set forth in any one of clauses <B52> to <B55>, in which the engagement section has the plate shape expanding along the pressing direction of the lever.

<B57>

A container holder, in which an inner bag containing a liquid material and including a mounting target section is removably installed, having: a handle section which can be held by a user; and an engagement target section which allows the engagement of an engagement section of a dispenser discharging the liquid material from the inner bag from a discharging opening in response to an operation of a user, in which a fixing member is provided to be able to fix the dispenser to the mounting target section of the inner bag installed in the container holder in a state where the engagement section is engaged with the engagement target section, and the engagement target section is provided to regulate the turning of the dispenser around the mounting target section of the inner bag installed in the container holder by the engagement of the engagement section.

<B58>

The container holder as set forth in clause <B57>, in which the engagement target section is provided in the handle section.

<B59>

The container holder as set forth in clause <B57> or <B58>, in which the handle section projects from the outer surface of the container holder to the same side as the mounting target section.

<B60>

The container holder as set forth in any one of clauses <B57> to <B59>, in which the engagement target section is provided in a corner portion of the handle section.

<B61>

The container holder as set forth in any one of clauses <B57> to <B60>, in which the engagement target section is a depression which allows the entering of the engagement section which is a projection.

<B62>

The container holder as set forth in any one of clauses <B57> to <B61>, in which the engagement target section has a slit shape which allows the entering of the engagement section having a plate shape.

<C1>

The discharge container as set forth in any one of clauses <B1> to <B15>, in which the dispenser is the dispenser as set forth in any one of clauses <1> to <29> and <A1> to <A15>.

<C2>

The dispenser as set forth in any one of clauses <B16> to <B25>, in which the dispenser is the dispenser as set forth in any one of clauses <1> to <29> and <A1> to <A15>.

<C3>

The container as set forth in any one of clauses <B26> to <B31>, in which the dispenser is the dispenser as set forth in any one of clauses <1> to <29> and <A1> to <A15>.

<C4>

The container holder with dispenser as set forth in any one of clauses <B32> to <B46>, in which the dispenser is the dispenser as set forth in any one of clauses <1> to <29> and <A1> to <A15>.

<C5>

The dispenser as set forth in any one of clauses <B47> to <B56>, in which the dispenser is the dispenser as set forth in any one of clauses <1> to <29> and <A1> to <A15>.

<C6>

The dispenser as set forth in any one of clauses <B57> to <B62>, in which the dispenser is the dispenser as set forth in any one of clauses <1> to <29> and <A1> to <A15>.

### INDUSTRIAL APPLICABILITY

The dispenser (i) of the present invention can increase the amount of the liquid material which can be discharged.

The dispenser (ii) of the present invention can smoothly operate the biasing unit for returning the elastically deformable lid section forming the pump chamber to the initial state in the dispenser including the lever.

The discharge container (iii) of the present invention can set the dispenser at a predetermined position and fix the dispenser to the container.

1-31. (canceled)

32: A dispenser capable of discharging a liquid material from a discharging opening comprising:
a dispenser body having a depression;
an elastically deformable lid section covering an opening of the depression and forming a pump chamber together with the depression;
a pressing portion arranged facing the lid section on an outside of the pump chamber, capable of pressing the lid section to a side where a volume of the pump chamber decreases, and provided to be able to enter an inside of the depression while pressing the lid section for elastic deformation;
an outlet causing the liquid material inside the pump chamber to flow out toward the discharging opening when the pressing portion presses the lid section; and
an inlet provided separately from the outlet and causing the liquid material to flow into the pump chamber when the pressing to the lid section by the pressing portion is released.

33: The dispenser according to claim 32, wherein the lid section bulges out to an opposite side to a side of the depression.

34: The dispenser according to claim 32, wherein the pressing portion has a shape corresponding to the depression.

35: The dispenser according to claim 32, wherein the lid section pressed by the pressing portion is elastically deformed into a shape following the depression in a state where the pressing portion enters the inside of the depression.

36: The dispenser according to claim 32, wherein the pressing portion is provided to press the lid section for elastic deformation, thereby allowing ⅓ or more of the lid section to enter the inside of the depression.

37: The dispenser according to claim 32, wherein the depression becomes gradually deeper toward a center side from an outer peripheral edge of the depression.

38: The dispenser according to claim 32 further comprising:
a biasing unit arranged inside the dispenser body and capable of pressing the lid section to a side where the volume of the pump chamber increases, wherein
a hole containing a part of the biasing unit is opened to a bottom portion of the depression, and
the pressing portion is provided to press the lid section for elastic deformation, thereby allowing a part of the lid section to enter an inside of the hole.

39: The dispenser according to claim 32 further comprising:
a lever rotatable with respect to the dispenser body, wherein the pressing portion has a projection shape projecting from the lever to a side of the lid section.

40: The dispenser according to claim 39, wherein a fulcrum of the lever is positioned at a height between the opening and a deepest part of the depression in side view of the depression.

41: The dispenser according to claim 39, wherein a shape of a tip surface of the pressing portion is provided such that an elastic deformation amount of the lid section is smaller on a side far from the fulcrum of the lever than on a side close to the fulcrum of the lever.

42: A dispenser capable of discharging a liquid material from a discharging opening comprising:
a dispenser body;
an elastically deformable lid section attached to the dispenser body and forming a pump chamber together with the dispenser body;
a biasing unit arranged inside the dispenser body and capable of pressing an inner surface of the lid section; and
a lever provided rotatably with respect to the dispenser body and having a pressing portion capable of pressing an outer surface of the lid section, wherein
the pressing portion and the biasing unit are provided such that, when the biasing unit starts to press the inner surface of the lid section in response to elastic deformation of the lid section by pressing by the pressing portion, a pressed site of the outer surface of the lid section by the pressing portion and a pressed site of the inner surface of the lid section by the biasing unit are superimposed on each other, and
the liquid material in the pump chamber is discharged from the discharging opening by the pressing to the lid section by the pressing portion.

43: The dispenser according to claim 42, wherein
the dispenser body has a depression,
the lid section is provided to cover an opening of the depression and has a bulging portion bulging out to an opposite side to a side of the depression, and
the pressing portion and the biasing unit are provided such that, when the biasing unit starts to press an inner surface of the bulging portion in response to elastic deformation of the bulging portion by the pressing by the pressing portion, a pressed site of an outer surface of the bulging portion by the pressing portion and a pressed site of the inner surface of the bulging portion by the biasing unit are superimposed on each other.

44: The dispenser according to claim 42, wherein a tip of the pressing portion facing the lid section has a projecting surface projecting toward the lid section.

45: A discharge container comprising:
a container having
a containing section containing a liquid material,
a handle section which can be held by a user,
a mounting target section, and
an engagement target section;
a dispenser having
a mounting section mounted to the mounting target section of the container, and
an engagement section engaged with the engagement target section of the container, and
discharging the liquid material from the containing section of the container from a discharging opening in response to an operation of a user; and
a fixing member fixing the dispenser to the container, wherein
the engagement section is provided to regulate turning of the dispenser around the mounting target section of the container by being engaged with the engagement target section, and
the fixing member is provided to be able to fix the dispenser to the container in a state where the engagement section is engaged with the engagement target section.
